(19) United States
(12) Patent Application Publication
(10) Pub. No.: US 2024/0227300 A1
(43) Pub. Date: Jul. 11, 2024

(54) METHODS FOR GENERATING SUPPORT STRUCTURES FOR ADDITIVELY MANUFACTURED OBJECTS

(71) Applicant: Align Technology, Inc., San Jose, CA (US)

(72) Inventors: Viswanath Meenakshisundaram, Santa Clara, CA (US); Yuxiang Wang, Newark, CA (US); Kangning Su, Pullman, WA (US); Shipin Qin, San Jose, CA (US); Siyi Liu, Plano, TX (US); Chang Xu, Milpitas, CA (US); Sudharshan Anandan, Sunnyvale, CA (US); Xirui Peng, Apex, NC (US)

(21) Appl. No.: 18/407,345

(22) Filed: Jan. 8, 2024

Related U.S. Application Data
(60) Provisional application No. 63/479,117, filed on Jan. 9, 2023.

(51) Int. Cl. B29C 64/386; A61C 13/20; B29C 64/40; B33Y 50/00

(52) U.S. Cl. CPC B29C 64/386; A61C 13/20; B29C 64/40; B33Y 50/00

(57) ABSTRACT

Methods and systems for generating support structures for additively manufactured objects are described herein. In some embodiments, a method includes receiving a digital representation of a dental appliance configured to implement a treatment stage of a treatment plan for a patient's teeth. The method can include generating a support structure arrangement configured to support the dental appliance during an additive manufacturing process. The support structure arrangement can be generated using a machine learning model. The machine learning model can be trained on a training data set including appliance data representing geometries of a plurality of dental appliances, support structure data representing geometries of a plurality of support structure arrangements, and outcome data representing outcomes of the additive manufacturing process for the plurality of dental appliances with the respective support structure arrangements.

### CROSS-REFERENCE TO RELATED APPLICATION(S)

The present application claims the benefit of priority to U.S. Provisional Application No. 63/479,117, filed Jan. 9, 2023, the disclosure of which is incorporated by reference herein in its entirety.

### TECHNICAL FIELD

The present technology generally relates to manufacturing, and in particular, to methods for generating support structures for additively manufactured objects.

### BACKGROUND

Additive manufacturing encompasses a variety of technologies that involve building up 3D objects from multiple layers of material. In some instances, support structures are added to the object during the additive manufacturing process to secure the object to the build platform, support unstable features, improve printing accuracy, and avoid stress-induced deformation. The locations and geometries of the support structures typically depend on the specific object geometry, such that different objects may require different arrangements of support structures. Conventional techniques for generating support structures for new object geometries generally involve significant computing resources and may require significant manual fine-tuning, and may therefore be unsuitable for large scale manufacturing of customized objects. Conventional techniques for generating support structures may also not be readily adaptable to different types of materials, products, and manufacturing systems without experimental validation. Moreover, conventional software for generating support structures may rely on generic algorithms that are not customized to the intended usage of the object and/or do not address considerations such as functionality, printing accuracy, material consumption, and/or ease of post-processing.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a block diagram illustrating a workflow for designing and fabricating dental appliances, in accordance with embodiments of the present technology.

FIG. 2A is a perspective view of a dental appliance with support structures, in accordance with embodiments of the present technology.

FIG. 2B is a perspective view of another dental appliance with support structures, in accordance with embodiments of the present technology.

FIG. 2C is a perspective view of another dental appliance with support structures, in accordance with embodiments of the present technology.

FIG. 2D is a perspective view of yet another dental appliance with support structures, in accordance with embodiments of the present technology.

FIG. 2E is a perspective view of another dental appliance with support structures, in accordance with embodiments of the present technology.

FIG. 2F is a perspective view of a dental appliance with support structures, in accordance with embodiments of the present technology.

FIG. 2G is a perspective view of a pair of dental appliances connected to a branched support structure, in accordance with embodiments of the present technology.

FIG. 3 is a block diagram illustrating a workflow for training an algorithm for generating and/or designing support structures, in accordance with embodiments of the present technology.

FIG. 4 illustrates a model that may be used as input to a simulation engine, in accordance with embodiments of the present technology.

FIG. 5A illustrates a training data set for an algorithm, in accordance with embodiments of the present technology.

FIG. 5B illustrates another training data set for an algorithm, in accordance with embodiments of the present technology.

FIG. 5C is a flow diagram illustrating a workflow for generating and/or designing support structures using a machine learning algorithm, in accordance with embodiments of the present technology.

FIG. 5D is a flow diagram illustrating a workflow for generating and/or designing support structures using a machine learning algorithm, in accordance with embodiments of the present technology.

FIG. 6A is a flow diagram illustrating a method for validating a support structure design via experimental testing, in accordance with embodiments of the present technology.

FIG. 6B is a flow diagram illustrating a method for validating a support structure design via simulation, in accordance with embodiments of the present technology.

FIG. 7A is a flow diagram illustrating a method for designing and fabricating dental appliances with support structures, in accordance with embodiments of the present technology.

FIG. 7B is a flow diagram illustrating a method for designing and fabricating dental appliances with support structures, in accordance with embodiments of the present technology.

FIG. 8 is a partially schematic diagram illustrating a method for using a reference support structure arrangement to generate a new support structure arrangement, in accordance with embodiments of the present technology.

FIG. 9A is a flow diagram illustrating a method for designing and fabricating dental appliances with support structures, in accordance with embodiments of the present technology.

FIG. 9B is a flow diagram illustrating an example of a support structure generation process, in accordance with embodiments of the present technology.

FIG. 10A illustrates a representative example of a tooth repositioning appliance configured in accordance with embodiments of the present technology.

FIG. 10B illustrates a tooth repositioning system including a plurality of appliances, in accordance with embodiments of the present technology.

FIG. 10C illustrates a method of orthodontic treatment using a plurality of appliances, in accordance with embodiments of the present technology.

FIG. 11 illustrates a method for designing an orthodontic appliance, in accordance with embodiments of the present technology.

FIG. 12 illustrates a method for digitally planning an orthodontic treatment and/or design or fabrication of an appliance, in accordance with embodiments of the present technology.

FIG. 13 is a partially schematic diagram providing a general overview of an additive manufacturing process, in accordance with embodiments of the present technology.

### DETAILED DESCRIPTION

The present technology relates to methods for generating support structures for additively manufactured objects. In some embodiments, for example, a method can include receiving a digital representation of a dental appliance configured to treat a patient's teeth, and generating a support structure arrangement configured to support the dental appliance during an additive manufacturing process. The support structure arrangement can be generated using a machine learning model that is trained on a training data set including: (1) appliance data representing geometries of a plurality of dental appliances, (2) support structure data representing geometries of a plurality of support structure arrangements, and/or (3) outcome data representing outcomes of the additive manufacturing process for the plurality of dental appliances with the respective support structure arrangements.

As another example, a method can include receiving a digital representation of a geometry of a dental appliance configured to treat a patient's teeth. The method can include accessing a datastore including a plurality of reference data sets, each reference data set including a reference appliance and a reference support structure arrangement associated with the reference appliance geometry. The method can also include identifying a reference appliance having a geometry similar to the geometry of the dental appliance, and generating a support structure arrangement for the dental appliance based on the reference support structure arrangement associated with the identified reference appliance.

The embodiments described herein can provide numerous advantages compared to conventional processes for generating support structures. For example, conventional processes may require significant computing resources to generate support structures for many different object geometries. The support structures generated by such processes may not actually perform as intended during fabrication (e.g., print failures may occur due to inadequate support structures), such that significant manual fine-tuning is often required. Experimental testing can be used to validate support structure designs, but such testing is typically expensive, time-consuming, and may not provide complete information on how and why failures occur. Simulations can be easier to perform than experimental testing, but may involve tradeoffs between computing time and accuracy, such that it may not be feasible to use simulations to evaluate each support structure design before fabrication.

The present technology can address these and other challenges by using machine learning models to generate support structures for different object geometries. The machine learning models can be trained on experimental data, simulation data, or combinations thereof. In some embodiments, simulation data can be used to create “virtual experimental data,” thus reducing the time and expense of experimental testing, as well as allowing for exploration of a larger design space in the training data set. The trained machine learning model can serve as a surrogate for experimental testing and/or simulations to evaluate support structure performance, thus allowing for rapid generation of support structures for many different objects that are likely to result in successful fabrication outcomes.

In some embodiments, the present technology uses previously validated support structures to generate support structures for new object geometries. Experimental data, simulation data, and/or machine learning models can be used to create a library of working examples that have produced successful fabrication outcomes (or are highly likely to produce successful outcomes). These working examples can serve as a basis for generating new support structures, thus reducing the amount of de novo design needed.

In some embodiments, the methods described herein provide support structures that are customized to the particular geometry and intended function of the object. For example, dental appliances for applying forces to teeth may require a higher degree of dimensional accuracy than other types of objects, and thus may benefit from support structures that are specifically designed to reduce or prevent deformation during manufacturing and/or post-processing. Alternatively or in combination, the support structures described herein can be designed in view of other considerations, such as reducing material consumption (e.g., by decreasing the total number and/or size of support structures) and/or improving the ease of post-processing (e.g., separation of the printed object from the support structures after printing).

Embodiments of the present disclosure will be described more fully hereinafter with reference to the accompanying drawings in which like numerals represent like elements throughout the several figures, and in which example embodiments are shown. Embodiments of the claims may however, be embodied in many different forms and should not be construed as limited to the embodiments set forth herein. The examples set forth herein are non-limiting examples and are merely examples among other possible examples. For instance, although certain embodiments are described herein in connection with support structures for dental appliances, this is not intended to be limiting, and the present technology can also be applied to support structures for other types of additively manufactured objects (e.g., molds for dental appliances, non-dental objects).

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Methods for Generating Support Structures

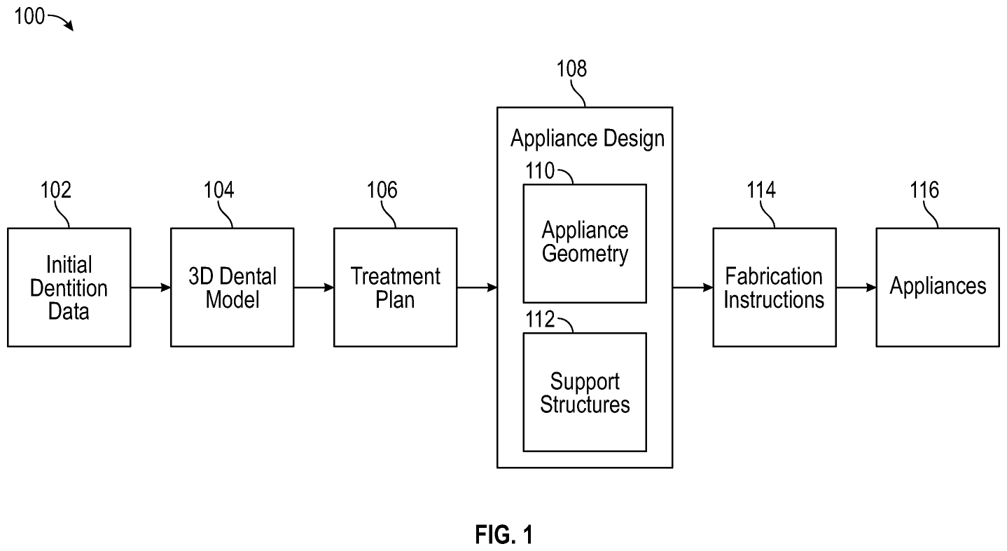

FIG. 1 is a block diagram providing a general overview of a workflow 100 for designing and fabricating dental appliances, in accordance with embodiments of the present technology. The workflow 100 begins at block 102 with receiving data representing the initial dentition of a patient. The initial dentition data can include image data of the patient's teeth generating using any suitable imaging modality, such as photographs, videos, scan data (e.g., intraoral and/or extraoral scans), magnetic resonance imaging (MRI) data, radiographic data (e.g., standard x-ray data such as bitewing x-ray data, panoramic x-ray data, cephalometric x-ray data, computed tomography (CT) data, cone-beam computed tomography (CBCT) data, fluoroscopy data), and/or motion data. The image data can include 2D data (e.g., 2D photographs or videos), 3D data (e.g., 3D photographs, intraoral and/or extraoral scans, digital models), 4D data (e.g., fluoroscopy data, dynamic articulation data, hard and/or soft tissue motion capture data), or suitable combinations thereof.

In some embodiments, for example, the initial dentition data is produced by a scanner via direct intraoral scanning or indirectly via casts, impressions, models, etc. The scanner can include a probe (e.g., a handheld probe) for optically capturing 3D structures (e.g., by confocal focusing of an array of light beams). Examples of scanners include, but are not limited to, the iTero® intraoral digital scanner manufactured by Align Technology, Inc., the 3M True Definition Scanner, and the Cerec Omnicam manufactured by Sirona®.

At block 104, the initial dentition data can be used to generate a 3D model of the patient's teeth (“3D dental model”). The 3D dental model can be any suitable digital representation of the 3D geometry of the teeth, such as a point cloud, mesh model, surface model, etc.

At block 106, the 3D dental model can be used to produce a treatment plan for the patient's teeth. The treatment plan can be manually generated by a human operator (e.g., a technician), automatically generated using software algorithms, or suitable combinations thereof. In some embodiments, the treatment planning process involves determining a target tooth arrangement to achieve one or more treatment goals prescribed by a clinician. The treatment plan can include a plurality of treatment stages to achieve the target tooth arrangement, such as a series of intermediate tooth arrangements configured to incrementally reposition the teeth from the initial tooth arrangement toward the target tooth arrangement. The target and intermediate tooth arrangements can be produced based on the 3D dental model. In some embodiments, the 3D dental model is used to produce a plurality of additional dental models corresponding to the target tooth arrangement and intermediate tooth arrangements.

At block 108, the workflow 100 can include designing one or more dental appliances for implementing the treatment plan. Examples of dental appliances include, but are not limited to, aligners, palatal expanders, retainers, attachment placement devices, attachments, oral sleep apnea appliances, and mouth guards. The appliance designs can be manually generated by a human operator (e.g., a technician), automatically generated using software algorithms, or suitable combinations thereof. In some embodiments, the appliance design includes a digital representation of the appliance geometry (block 110), such as a point cloud, mesh model, surface model, parametric model, non-parametric model, or other model depicting the size, shape, and features of the appliance. Optionally, the appliance design can incorporate features to facilitate post-processing, such as holes in the surfaces of the appliance to allow resin to drain from the appliance after printing.

The appliance design can also include a digital representation of a plurality of support structures (block 112) for supporting the dental appliance during an additive manufacturing process. The support structures can include components configured to connect the dental appliance to a build platform (e.g., a printer bed, tray, plate, film, sheet, or other planar substrate) during additive manufacturing and/or post-processing, such as cones, pillars, struts, lattices, bridges, pins, trees, etc. Alternatively or in combination, the support structures can include components configured to reduce or prevent deformation of the dental appliance during additive manufacturing and/or post-processing, such as crossbars, blocks, wedges, frames, etc. The support structures can be formed directly on the build platform, or can be formed on a sacrificial material base (e.g., a raft, layer, film, mesh, grid) that provides a larger surface area to improve adhesion to the build platform.

The geometry (e.g., size, shape), locations, density, and/or other characteristics of the support structures can be customized to the particular characteristics of the dental appliance, as well as the additive manufacturing and/or post-processing techniques to be used for the dental appliance. For instance, the support structures can be designed to ensure that the dental appliance remains securely attached to the build platform during the additive manufacturing process. Support structures may also be beneficial or necessary if the dental appliance includes unstable structures that would deform and/or collapse without additional stabilization, such as overhangs, bridges, islands, valleys, regions having relatively low stiffness, etc. Support structures can also ensure that all surfaces of the dental appliance are printed in the correct relative position, improve dimensional accuracy and tolerances, and/or prevent stress-induced deformation (e.g., warping, shrinkage) during additive manufacturing and/or post-processing.

Moreover, the support structures can be designed to enhance ease of post-processing the dental appliances. For instance, support structures can be positioned at the cutline of the dental appliance, which allows for removal of the support structures via automatic laser trimming for large scale production. Alternatively or in combination, the support structures can be selectively weakened at the connection regions to the dental appliance to facilitate removal of the support structures during post-processing, such as by reducing the thickness of the support structures at the connection regions, using grayscaling control of the additive manufacturing energy source to reduce the degree of cure at the connection regions, forming the connection regions from a weaker and/or degradable material, etc.

In some embodiments, the support structures are designed to reduce material usage and costs. For example, the number, size, and/or density of the support structures can be dynamically varied for different regions of a dental appliance (e.g., crown regions may be more important than interproximal regions and thus may require more support structures to prevent deformation). The printing orientation of the dental appliance can also be adjusted to reduce the total number of support structures needed. In some embodiments, dental appliances printed in a vertical or tilted orientation may require fewer support structures than dental appliances printed in a horizontal orientation. Multiple dental appliances can be interconnected via a network of support structures to reduce the total amount of support structures needed.

The presence of support structures may also affect the final geometry of the dental appliance. For example, in the absence of support structures, the dental appliance may exhibit significant global deformation (e.g., arch expansion) but relatively little local deformation (e.g., changes in shape of individual tooth-receiving cavities). In some instances, support structures may cause local deformation (e.g., the individual tooth-receiving cavities of the dental appliance may deform outward and/or shrink in an anterior-posterior direction) but relatively little global deformation. Accordingly, the algorithms for designing support structures described further herein can be configured to predict deformations of the dental appliance that are attributable to the presence of the support structures, and to adjust the geometry and/or position of the support structures to avoid undesirable deformations and/or ensure that deformations occur primarily at locations that do not significantly affect the function of the dental appliance.

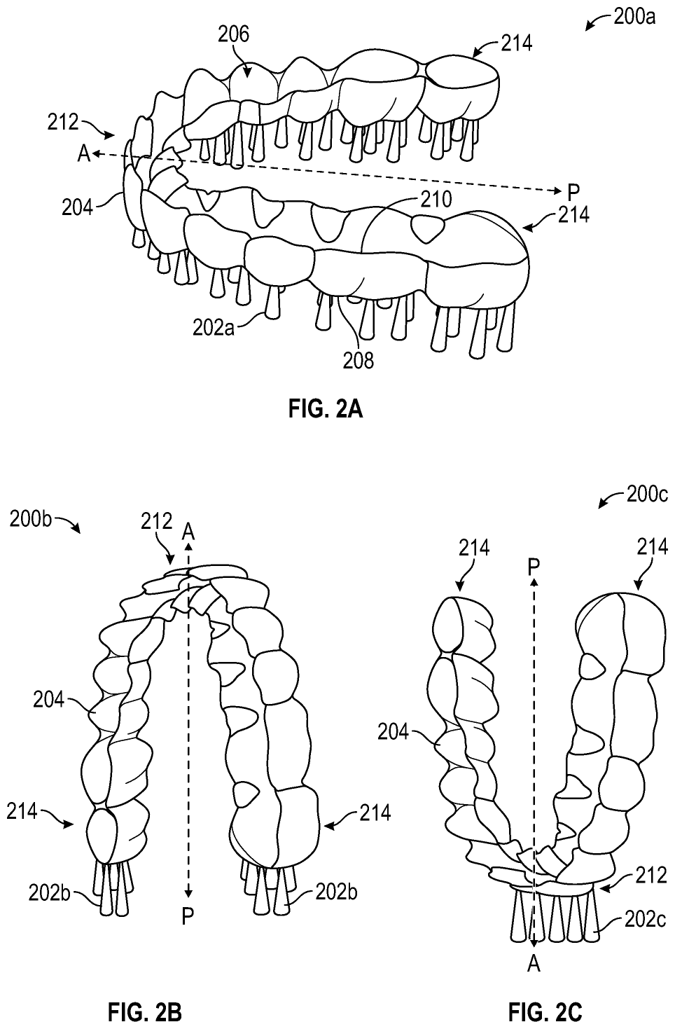

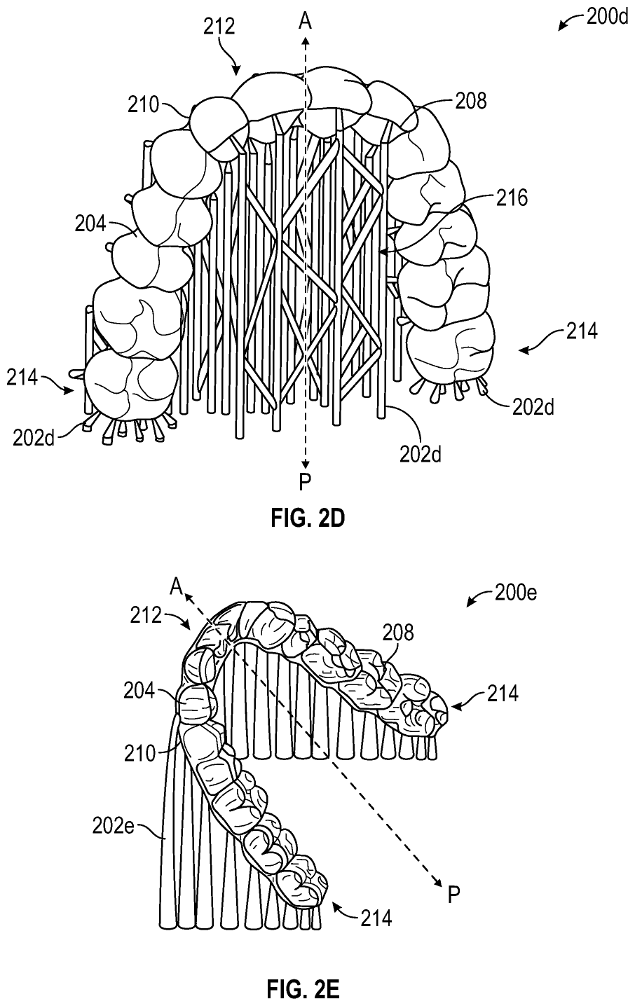

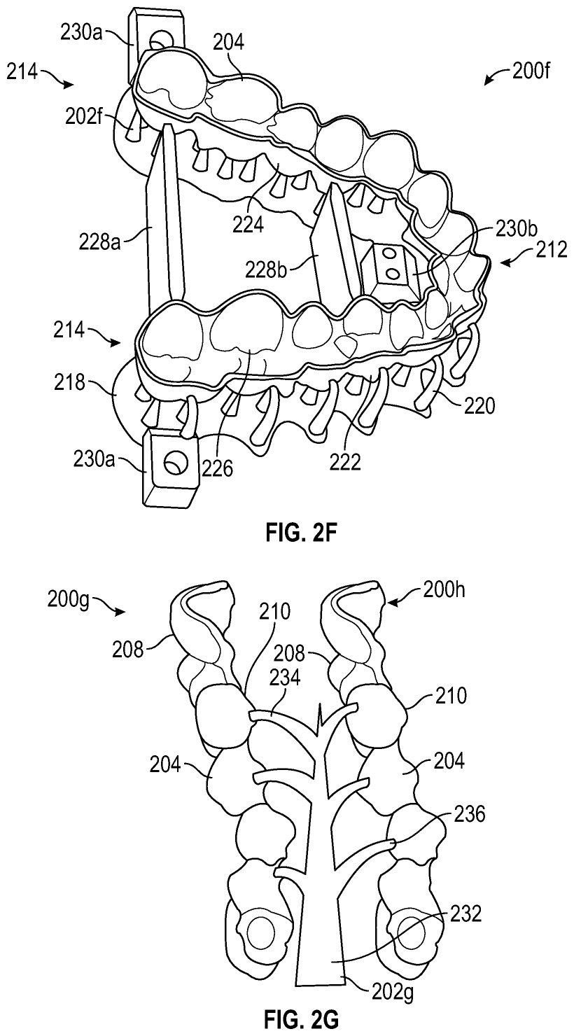

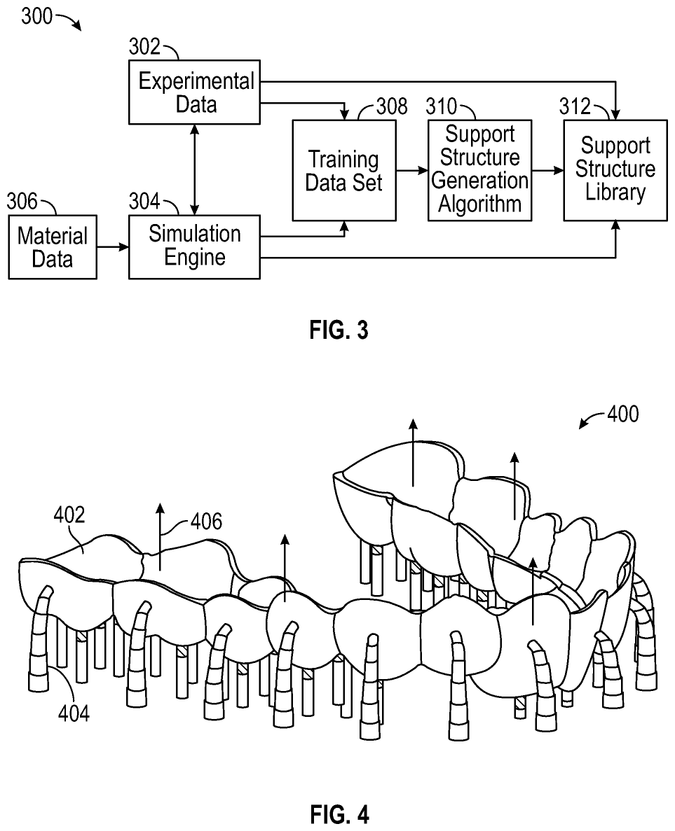

Representative examples of support structures of the present technology are described below in connection with FIGS. 2A-2G. The appropriate support structures for a particular dental appliance geometry can be determined using simulations, experimental testing, software algorithms (e.g., trained machine learning models, transformation algorithms), or suitable combinations thereof. Representative examples of methods for generating support structures for dental appliances are discussed further below with respect to FIGS. 3-9B.

At block 114, the workflow 100 can include producing a set of fabrication instructions configured to control a fabrication system to manufacture the appliance design. In some embodiments, the instructions are or include a 3D digital representation of the appliance design, such as a CAD file, STL file, OBJ file, AMF file, 3MF file, etc. Alternatively or in combination, the instructions can include a toolpath file (e.g., a G-code file) generated from the 3D digital representation of the appliance design.

At block 116, one or more dental appliances are fabricated. In some embodiments, the dental appliances are directly fabricated using an additive manufacturing system. Additive manufacturing (also referred to herein as “3D printing”) includes a variety of technologies which fabricate 3D objects directly from digital models through an additive process. In some embodiments, additive manufacturing includes depositing a precursor material onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry. Additional details and examples of additive manufacturing techniques suitable for use with the present technology are provided in Section III below.

In some embodiments, the fabrication process of block 116 includes performing one or more post-processing operations, after the dental appliance is additively manufactured. For example, residual material such as excess precursor material (e.g., uncured resin) and/or other unwanted material (e.g., debris) that remains on or within the appliance after the additive manufacturing process can be removed, such using solvents (e.g., spraying, immersion), heating or cooling, vacuum, blowing pressurized gas, applying mechanical forces (e.g., vibration, agitation, centrifugation, tumbling, brushing), and/or other suitable techniques. As another example, additional curing (also known as “post-curing”) can be performed in situations where the appliance is still in a partially cured “green” state after fabrication. Post-curing can provide various benefits, such as improving the mechanical properties (e.g., stiffness, strength) and/or temperature stability of the appliance. Post-curing can be performed by heating the appliance, applying radiation (e.g., UV, visible, microwave) to the appliance, or suitable combinations thereof. Other post-processing operations that may be performed include, but are not limited to, annealing, separating the appliance from the support structures, cleaning, trimming, surface modifications, sorting, and/or packaging.

Optionally, some or all of the appliances can be indirectly fabricated via thermoforming. Thermoforming can involve producing a mold of the patient's dentition in an intermediate or target arrangement, then thermoforming one or more sheets of material over the mold in order to generate a dental appliance corresponding to the intermediate or target arrangement. The molds can be fabricated using an additive manufacturing process. In some embodiments, the molds may not require any support structures, while in other embodiments, the molds can include support structures. For instance, support structures may be appropriate if the molds include overhangs (e.g., due to significantly inclined teeth), bridges (e.g., due to missing teeth), and/or other unstable structures. Support structures can also be included to improve printing accuracy of the molds and/or avoid deformation during post-processing. Any methods described herein in connection with generating support structures for dental appliances can alternatively or additionally be adapted for generating support structures for molds for dental appliances.

FIGS. 2A-2G illustrate representative examples of dental appliances with support structures configured in accordance with embodiments of the present technology. The embodiments of FIGS. 2A-2G can be designed and fabricated using any of the methods described herein. Additionally, any of the embodiments of FIGS. 2A-2G can be combined with each other and/or with other embodiments of dental appliances and support structures described herein.

FIG. 2A is a perspective view of a dental appliance 200a with support structures 202a configured in accordance with embodiments of the present technology. The dental appliance 200a can be an aligner, palatal expander, attachment placement device, distalizer, mouth guard, sleep apnea device, etc. In the illustrated embodiment, the dental appliance 200a includes a shell 204 forming a plurality of teeth-receiving cavities 206. The shell 204 can include one or more occlusal surfaces 208 configured to be positioned proximate to the occlusal surfaces of the patient's teeth, and one or more gingival edges 210 configured to be positioned proximate to the gingival margin of the teeth. The gingival edges 210 can correspond to the cutline of the dental appliance 200a.

The support structures 202a can connect the dental appliance 200a to the surface of a build platform (not shown) during additive manufacturing and/or post-processing. The support structures 202a can be formed directly on the build platform, or can be formed on a base (not shown) that is formed directly on the build platform. The support structures 202a can have any suitable shape, such as a shape with a uniform diameter and/or width (e.g., cylindrical, rectangular), a shape with a variable diameter and/or width (e.g., conical), a straight and/or linear shape, a curved and/or bent shape, a branched shape (e.g., a tree structure), a non-branched shape, or suitable combinations thereof. The cross-sectional shape of each support structure 202a can be circular, elliptical, square, rectangular, triangular, polygonal, or suitable combinations thereof. In some embodiments, the support structures 202a are discrete components that are not directly connected to each other. Alternatively, some or all of the support structures 202a can be interconnected to form a continuous lattice or network of support structures 202a. The size of the support structures 202a can also be varied as desired. For example, the support structures 202a can have a width and/or diameter that is less than or equal to 5 mm, 2 mm, 1 mm, 0.75 mm, 0.5 mm, or 0.25 mm; and/or greater than or equal to 0.1 mm, 0.25 mm, 0.5 mm, 0.75 mm, 1 mm, or 2 mm. The height of the support structures 202a can be less than or equal to 50 mm, 20 mm, 10 mm, 5 mm, 2 mm, or 1 mm; and/or greater than or equal to 0.5 mm, 1 mm, 2 mm, 5 mm, 10 mm, or 20 mm.

In the illustrated embodiment, for example, the support structures 202a each have a conical shape with a wider base and a narrower apex. The base of the cone can be attached to the build platform, and the apex of the cone can be attached to the dental appliance 200a. In other embodiments, some or all of the support structures 202a can have a different geometry. For instance, some or all of the support structures 202a can be inverted so that the base of the cone is attached to the dental appliance 200a and the apex of the cone is attached to the build platform. In some embodiments, the support structures 202a are distributed along the entire arch of the shell 204, while in other embodiments, the support structures 202a can be localized to selected regions of the shell 204 (e.g., the anterior region 212 and/or the posterior regions 214).

In the embodiment of FIG. 2A, the dental appliance 200a is in a horizontal orientation, such that the anterior-posterior axis of the shell 204 (axis A-P) is parallel to the surface of the build platform. The occlusal surfaces 208 of the shell 204 can be oriented toward the surface of the build platform, while the gingival edges 210 and teeth-receiving cavities 206 of the shell 204 are oriented away from the build platform. The support structures 202a can be connected to the occlusal surfaces 208 of the shell 204, with the height of each support structure 202a varying according to the local topography of the occlusal surfaces 208. In other embodiments, the dental appliance 200a can be flipped so that the gingival edges 210 are oriented toward the build platform, while the occlusal surfaces 208 are oriented away from the build platform. In such embodiments, the support structures 202a can be connected to the gingival edges 210 of the shell 204 and/or to the interior surfaces of the teeth-receiving cavities 206.

FIG. 2B is a perspective view of another dental appliance 200b with support structures 202b configured in accordance with embodiments of the present technology. The dental appliance 200b can be identical or generally similar to the dental appliance 200a of FIG. 2A, except that the dental appliance 200b is in a vertical orientation, such that the anterior-posterior axis of the shell 204 of the dental appliance 200b is orthogonal to the surface of the build platform (not shown). The posterior regions 214 of the shell 204 can be oriented toward the surface of the build platform, while the anterior region 212 of the shell 204 is oriented away from the build platform. The support structures 202b (e.g., cones, pillars, struts) can connect the posterior regions 214 of the shell 204 to the build platform. The configuration shown in FIG. 2B can be advantageous for reducing the number of support structures 202b used to support the dental appliance 200b, which can decrease material costs and printing time. Additionally, the configuration of FIG. 2B can have a smaller footprint that allows more dental appliances to be fabricated on a single build platform.

FIG. 2C is a perspective view of another dental appliance 200c with support structures 202c configured in accordance with embodiments of the present technology. The dental appliance 200c can be identical or generally similar to the dental appliance 200b of FIG. 2B, except the dental appliance 200c is in a flipped vertical orientation in which the anterior regions 212 are oriented toward the surface of the build platform (not shown) and the posterior regions 214 are oriented away from the build platform. The support structures 202c (e.g., cones, pillars, struts) can connect the anterior region 212 to the build platform. The configuration shown in FIG. 2C can be advantageous for reducing the number of support structures 202c used to support the dental appliance 200c, which can decrease material costs and printing time. Additionally, the configuration of FIG. 2C can have a smaller footprint that allows more dental appliances to be fabricated on a single build platform.

FIG. 2D is a perspective view of yet another dental appliance 200d with support structures 202d configured in accordance with embodiments of the present technology. The dental appliance 200d can be identical or generally similar to the dental appliance 200b of FIG. 2B. For instance, the dental appliance 200d is in a vertical orientation, with the posterior regions 214 oriented toward the build platform (not shown), and the anterior region 212 oriented away from the build platform. Some of the support structures 202d can be located proximate to the posterior regions 214 of the shell 204 to connect the posterior regions 214 to the build platform, similar to the embodiment of FIG. 2B. Additionally, some of the support structures 202d can be located within or proximate to the lingual space 216 defined by the arch of the shell 204, and/or can connect to the occlusal surfaces 208 and/or gingival edges 210 of the shell 204. In the illustrated embodiment, the support structures 202d within the lingual space 216 are interconnected to form a lattice. This configuration can be beneficial for reducing or preventing deformation of the dental appliance 200d along the arch expansion direction.

FIG. 2E is a perspective view of another dental appliance 200e with support structures 202e configured in accordance with embodiments of the present technology. The dental appliance 200e can be identical or generally similar to the embodiments of FIGS. 2A-2D, except that the dental appliance 200e is in a tilted orientation with the anterior-posterior axis at an angle relative to the build platform (not shown). For example, the anterior-posterior axis can be at an angle greater than or equal to 2°, 5°, 10°, 15°, 20°, 30°, 40°, 45°, 50°, 60°, 70°, or 80° relative to the surface of the build platform, and/or an angle less than or equal to 85°, 80°, 70°, 60°, 50°, 45°, 30°, 20°, or 10° relative to the surface of the build platform. The support structures 202e can connect the shell 204 of the dental appliance 200e to the build platform, with the height of each support structure 202e varying according to the local height of the shell 204 above the surface of the build platform. This configuration can reduce the amount of overhang in the dental appliance 200e, and thus decrease the amount of support structures 202e needed to stabilize the dental appliance 200e during additive manufacturing.

Although FIG. 2E illustrates the dental appliance 200e as being oriented with the occlusal surfaces 208 facing away from the build platform and the gingival edges 210 facing toward the build platform, in other embodiments, the dental appliance 200e can be flipped so the occlusal surfaces 208 face toward the build platform and the gingival edges 210 face away from the build platform. Additionally, although the dental appliance 200e is depicted with the anterior region 212 being higher than the posterior regions 214, in other embodiments, the posterior regions 214 can be higher than the anterior region 212.

FIG. 2F is a perspective view of a dental appliance 200f with a plurality of support structures 202f configured in accordance with embodiments of the present technology. In the illustrated embodiment, the support structures 202f are formed on a base 218 of flattened material (e.g., a raft, layer, film, mesh, grid) that is attached to the surface of the build platform (not shown), which can be advantageous for improving adhesion to the build platform. In other embodiments, the base 218 is optional and can be omitted.

As shown in FIG. 2F, the support structures 202f can include one or more curved arms 220 (e.g., bridges) connecting the shell 204 to the build platform. The curved arms 220 can provide improved stiffness and stability, and thus can enhance resistance to forces that may be applied to the dental appliance 200f during the additive manufacturing process and/or post-processing, such as shear forces. In some embodiments, the curved arms 220 are connected to the exterior of the buccal surfaces 222 and/or lingual surfaces 224 of the shell 204 to reduce or prevent deformation of these surfaces (FIG. 2F shows curved arms 220 at the buccal surfaces 222 only merely for purposes of simplicity). This configuration can improve the print accuracy of the interior surfaces 226 of the shell 204, which typically directly contact the teeth and may therefore require higher accuracy than other portions of the dental appliance 200f.

In some embodiments, the support structures 202f include one or more crossbars 228a, 228b connecting the left and right sides of the shell 204. The shell 204 may be less stiff and more susceptible to deformation along the arch expansion direction. Accordingly, the crossbars 228a, 228b can reinforce the shell 204 in the arch expansion direction to improve stability and printing accuracy during manufacturing and/or post-processing.

Optionally, the support structures 202f can include one or more blocks 230a, 230b. The blocks 230a, 230b can serve as dimensional references that are measurable to check the printing accuracy of the dental appliance 200f (e.g., during quality control). Thus, the blocks 230a, 230b can be used to assess whether deformation of the dental appliance 200f occurred during manufacturing and/or post-processing. In the illustrated embodiment, the support structures 202f includes a pair of side blocks 230a and a central block 230b. The side blocks 230a can be positioned at the left and right posterior regions 214 of the shell 204, respectively, and can be located proximate to but spaced apart from the buccal surfaces 222 of the shell 204. The central block 230b can be positioned within the lingual space at the anterior region 212 of the shell 204, and can be located proximate to but spaced apart from the lingual surface 224 of the shell 204. In other embodiments, however, some or all of the blocks 230a, 230b can be positioned at different locations relative to the shell 204, or can be omitted altogether.

FIG. 2G is a perspective view of a pair of dental appliances 200g, 200h connected to a branched support structure 202g, in accordance with embodiments of the present technology. The branched support structure 202g can simultaneously support multiple dental appliances during manufacturing and/or post-processing. This configuration can be beneficial for reducing the total amount of support structures needed, and thus decrease material usage and costs. Although FIG. 2G shows two dental appliances 200g, 200h, in other embodiments, the branched support structures 202g can be connected any suitable number of dental appliances (e.g., three, four, five, or more dental appliances).

In some embodiments, the branched support structure 202g includes a trunk 232, one or more first branches 234, and one or more second branches 236. The trunk 232 can be coupled to and extend upwardly from the surface of the build platform (not shown). Although the trunk 232 is depicted as having a tapered (e.g., conical) shape, in other embodiments, the trunk 232 can have a different shape, such as a shape with a uniform width and/or diameter.

As shown in FIG. 2G, the trunk 232 can be positioned between a first dental appliance 200g and a second dental appliance 200h. The first branches 234 can connect the shell 204 of the first dental appliance 200g to the trunk 232, and the second branches 236 can connect the shell 204 of the second dental appliance 200h to the trunk 232. In some embodiments, the dental appliances 200g, 200h are supported only by the branched support structure 202g. Alternatively, one or both of the dental appliances 200g, 200h can also include respective support structures that connect each appliance to the build platform.

In the illustrated embodiment, the dental appliances 200g, 200h are facing the same direction, such that the first branches 234 are coupled to the gingival edges 210 of the first dental appliance 200g, and the second branches 236 are coupled to the occlusal surfaces 208 of the second dental appliance 200h. Alternatively, the dental appliances 200g, 200h can face different directions, such that the first and second branches 234, 236 are coupled to the gingival edges 210 of the first and second dental appliances 200g, 200h, respectively, or the first and second branches 234, 236 are coupled to the occlusal surfaces 208 of the first and second dental appliances 200g, 200h, respectively. Although the dental appliances 200g, 200h are shown as both being in a vertical orientation, in other embodiments, one or both of the dental appliances 200g, 200h can be a different orientation (e.g., a horizontal orientation or a tilted orientation).

FIG. 3 is a block diagram illustrating a workflow 300 for training an algorithm for generating and/or designing support structures, in accordance with embodiments of the present technology. The algorithm, which may be referred to interchangeably herein as a “support structure generation algorithm” or a “support structure design algorithm,” can be an automated software algorithm that determines an appropriate arrangement of support structures for supporting a dental appliance (or dental mold or other object) during an additive manufacturing process. Alternatively or in combination, the support structure generation algorithm can predict a manufacturing outcome for a dental appliance fabricated with a particular support structure arrangement (e.g., whether the appliance will have printability issues and/or will deviate from its intended geometry), and can modify the support structure arrangement to improve printability and/or accuracy. In some embodiments, the support structure generation algorithm is used in connection with the process of block 112 of FIG. 1.

At block 302, the workflow 300 can include generating and/or receiving experimental data. The experimental data can include results from fabricating and/or experimentally testing one or more arrangements of support structures for supporting different appliance geometries. The results can include any of the following: fabrication results (e.g., whether the appliance with support structures was successfully fabricated via additive manufacturing and/or post-processing), dimensional accuracy results (e.g., deviation between the actual appliance geometry and the planned appliance geometry), force testing results (e.g., deviations between actual forces produced by the appliance and planned forces), deformation testing results (e.g., amount of deformation of the appliance and/or support structures), stress testing results (e.g., stress distribution within the appliance and/or support structures), and/or any other relevant measurements of appliance properties. Experimental testing can be performed at any suitable stage in the fabrication procedure, such as during and/or after additive manufacturing; and/or before, during, and/or after post-processing (e.g., before, during, and/or after centrifugation and/or post-curing).

Optionally, experimental testing can be performed on reference objects (e.g., coupons) having a simplified and/or standardized geometry (e.g., blocks, tubes, arches) that incorporates one or more appliance features that are frequently used in dental appliances. The appliance features can be represented in the reference object in a manner that encompasses the range of variations that are likely to be present in actual dental appliances, such as a plurality of different sizes, shapes, locations, etc. In some embodiments, experimental testing is performed on a set of dental appliances (e.g., dental appliances that are representative of typical appliance geometries) and a set of reference objects (e.g., coupons that encompass a wide range of features and complexities that are relevant to actual dental appliances).

At block 304, the workflow 300 can include generating and/or receiving simulation data produced by a simulation engine. The simulation engine can be any software component configured to run at least one simulation, such as a simulation using the finite element method (FEM). FEM simulations may provide greater accuracy, but may be computationally intensive and time-consuming to perform. Optionally, the simulation can be a reduced order model (ROM) from a set of FEM simulations, either by simplified FEMs or direct end-to-end machine learning models, to increase computational speed and reduce the computing resources needed. For example, the simulation can represent material properties using linear models rather than nonlinear models and/or the model output can be approximated with a polynomial response surface.

In some embodiments, the simulation engine receives a digital representation (e.g., a 3D model) of the appliance geometry and support structure arrangement. The simulation engine can also receive load data indicating the magnitude and/or direction of loading to be applied to the appliance geometry and support structure arrangement in the simulation. For example, the load data can indicate one or more forces that would be applied to the appliance and support structures during additive manufacturing process and/or post-processing, such as gravitational forces, centrifugation forces, forces exerted by an additive manufacturing system (e.g., shear forces, hydrostatic forces from resin due to compression by the printer assembly and/or high object packing density), forces exerted during washing, etc., or suitable combinations thereof. Additionally, the simulation engine can receive material data (block 306) corresponding to the properties of the material(s) to be used to fabricate the appliance and support structures. For example, the material data can include the modulus (e.g., elastic modulus (Young's modulus), flexural modulus), yield stress, stress relaxation, creep rates, weights, and/or other mechanical properties of the material. The material data can also include information regarding interdependencies of various properties of the material, such as interdependencies between moduli, thickness, and temperature. The material data can include values of time-dependent properties (e.g., stress relaxation, creep rate, weight) measured at different time scales. The material data can include the properties of the material before post-curing (e.g., when in a green state), after post-curing (e.g., when in a fully cured state), at room temperature, at elevated temperatures (e.g., printing temperature, post-processing temperature, physiological temperature) and/or suitable combinations thereof.

For example, FIG. 4 illustrates a model 400 that may be used as input to the simulation engine, in accordance with embodiments of the present technology. The model 400 can be a finite element model suitable for use in an FEM simulation, as described above. In the illustrated embodiment, the model 400 is a shell and beam model including a shell element 402 representing the dental appliance geometry, and a plurality of beam elements 404 (e.g., tapered beams) representing the geometries of the support structures. A shell and beam model may abstract the geometries of the dental appliance and support structures to 2D and 1D elements, respectively, and may therefore be less computationally intensive to simulate compared to solid models. In other embodiments, however, the model 400 can instead represent the dental appliance and/or support structures as solid (3D) elements.

The model 400 can be used to simulate the behavior of the dental appliance and support structures at various stages in the fabrication procedure. In some embodiments, for example, the model 400 is used to simulate stress concentration and/or deformation of the dental appliance and support structures during a centrifugation process to remove excess resin after printing. The centrifugal force (indicated by arrows 406, the direction of which may depend on the process) can be simulated as a body force using the equation f=pw²r, where w is the maximum rotational velocity (e.g., within a range from 100 RPM to 1000 RPM) and is the distance from the center of rotation (e.g., 10 inches). The material properties used in the simulation can correspond to the material properties of the dental appliance and support structures in a cured state at room temperature (e.g., an elastic modulus within a range from 500 MPa to 2000 MPa and/or a yield stress within a range from 10 MPa to 50 MPa). In other embodiments, the material properties used in the simulation can instead correspond to the material properties of the dental appliance and support structures in a green state, which may exhibit lower yield stress and/or viscoelastic behavior compared to the cured state. Optionally, the material properties used in the simulation can include viscoelastic properties that vary as a function of temperature to predict deformation of the dental appliance and/or support structures at different temperatures (e.g., when simulating a heated centrifugation process).

Referring again to FIG. 3, the simulation engine can evaluate the behavior of the appliance geometry and support structures under the simulated load, such as the stress distribution, strain distribution, deformation, displacement, generated forces, etc. The simulation can be performed at any suitable stage in the fabrication procedure, such as during and/or after additive manufacturing; and/or before, during, and/or after post-processing (e.g., before, during, and/or after centrifugation and/or post-curing). For example, the simulation can be used to measure the stress concentration and/or maximum stress in the appliance to predict types and/or locations of failures that may occur during the fabrication procedure. As another example, the simulation can be used to measure the maximum displacement of the appliance under loading, e.g., to quantify whether the support structure arrangement is adequate. In a further example, the simulation can predict stress and/or deformation of the appliance when exposed to different temperatures (e.g., elevated temperatures above room temperature).

The output of the simulation engine can be used to predict whether a particular support structure arrangement will successfully support the dental appliance during additive manufacturing and/or post-processing. For example, the support structure arrangement can be considered successful if simulated stress in the appliance and/or support structure arrangement is no greater than a predetermined threshold corresponding to plastic deformation, fracture, collapse, detachment and/or other failure mode. As another example, the support structure arrangement can be considered successful if the simulated deformation and/or displacement is no greater than a predetermined threshold corresponding to an acceptable dimensional error in the appliance geometry. Optionally, the threshold(s) used can vary based on location, e.g., larger stresses and/or deformations may be permissible in locations that are not intended to apply forces to teeth. The use of simulation data can provide various benefits, such as allowing for quantification of failures, assessment of different failure modes, providing faster and more cost-effective data collection compared to experimental testing, reducing the amount of noise in the data, providing more detailed data than what can be obtained experimentally, and/or providing accurate predictions of appliance performance even if the actual sequence of processing steps changes.

Optionally, as indicated by the arrows between blocks 302 and 304, the simulation data produced by the simulation engine can be experimentally validated. For example, if the simulation predicts that a particular support structure arrangement will successfully support a dental appliance geometry, the dental appliance and support structure arrangement can subsequently be fabricated and tested to see if the actual experimental data matches or is at least consistent with the simulation data. If the experimental data does not match the simulation data, this information can be used as feedback to modify the simulation engine to improve the accuracy of the simulation. In some embodiments, only a subset of the simulation data is experimentally validated, while in other embodiments, all of the simulation data is experimentally validated.

At block 308, the experimental data and/or the simulation data can be used to produce a training data set for the support structure generation algorithm. The training data set can be produced using experimental data only, simulation data only, experimentally-validated simulation data only, or a combination of experimental data and simulation data. For example, experiments may be expensive and/or time-consuming to perform, such that it may be simpler to use simulations to produce a large amount of “virtual experimental data” to explore many different appliance and support structure designs. Optionally, to improve accuracy, the training data set may be limited to simulation data that has either been validated by experimental data or is sufficiently similar to validated simulation data.

In some embodiments, the training data set includes appliance data representing the geometries of a plurality of dental appliances, support structure data representing the geometries of a plurality of support structure arrangements, and outcome data representing simulated and/or experimental outcomes of manufacturing each dental appliance with the corresponding support structure arrangement. For instance, the training data set can be subdivided into a plurality of individual sets, each set including appliance data for a particular dental appliance, support structure data for a support structure arrangement for that dental appliance, and outcome data representing the simulated and/or experimental outcome of manufacturing the dental appliance with the support structure arrangement.

The appliance data for a particular dental appliance can include a plurality of geometric parameters representing various features of the dental appliance (also referred to herein as “appliance parameters”). Examples of appliance parameters include, but are not limited to, curvature (e.g., Gaussian curvature, mean curvature, radius of curvature), thickness (e.g., local appliance shell thickness, which may correspond to the shortest distance from a specific point on a surface to the closet point on an opposing surface that is parallel or nearly parallel to the surface), location of the appliance on the build platform, location of the appliance within the print area, surface normal, distance to occlusal surface, appliance size, appliance complexity, tooth centroid, local overhang angle (e.g., angle between the local tangent to the appliance surface at a point of interest and the vertical axis), distance to the closest supporting point (e.g., shortest distance from a point of interest on the appliance to the nearest point that can provide structural support). The appliance parameters can be computed at one or more specific points of the appliance geometry (e.g., the curvature, surface normal, distance to occlusal surface, thickness, local overhang angle, and distance to the closest supporting point can be calculated at each vertex of the appliance geometry), over one or more regions of the appliance geometry (e.g., a tooth centroid can be calculated for each tooth-receiving cavity of the appliance), over the entirety of the appliance geometry (e.g., appliance size and complexity can be determined with respect to the entire appliance), or suitable combinations thereof. In some embodiments, the appliance parameters are determined by receiving a 3D model of the dental appliance (e.g., a point cloud, surface, or mesh model), then parameterizing the 3D model using an analytic and/or numerical function. The output of the function can be a set of numerical values that can be input directly into the support structure generation algorithm.

The support structure data can include a plurality of geometric parameters representing various features of the support structure arrangement associated with the dental appliance (also referred to herein as “support structure parameters”). Examples of support structure parameters include, but are not limited to, diameter, height, density, conic profile, non-conic profile (e.g., for macroscopic support structures such as crossbars), overhang, and turn/bend radius. The support structure parameters can be computed for individual support structures in the arrangement (e.g., the diameter, height, conic profile, overhand, and turn/bend radius can be calculated for each support structure), for one or more subsets of support structures in the arrangement (e.g., the density can be computed locally for specific groups of support structures), for all the support structures in the arrangement (e.g., the density can be computed globally for the entire support structure arrangement), or suitable combinations thereof. In some embodiments, the support structure parameters are determined by receiving a 3D model of the support structure arrangement (e.g., a point cloud, surface, or mesh model), then parameterizing the 3D model using an analytic and/or numerical function. The output of the function can be a set of numerical values that can be input directly into the support structure generation algorithm.

The outcome data can include a plurality of parameters representing simulated and/or experimental outcomes of manufacturing the dental appliance with the support structure arrangement (also referred to herein as “outcome parameters.” For instance, the outcome parameters can include qualitative indications (e.g., “pass” versus “fail”) of whether the dental appliance with the support structure arrangement was successfully fabricated via additive manufacturing (e.g., the entire appliance was printed without becoming detached from the build platform, collapsing, and/or any other printing errors), whether the dental appliance with the support structure arrangement was successfully post-processed (e.g., the appliance survived centrifugation), and/or any other relevant manufacturing outcomes. Alternatively or in combination, the outcome parameters can include numerical values, such as the deviation between the planned and actual appliance geometry (also referred to herein as “dimensional error”), the deviation between the planned forces and actual forces produced by the appliance (also referred to herein as “force error”), the amount of deformation exhibited by the appliance during fabrication and/or post-processing, and/or any other relevant measurements. The numerical values can be computed for one or more specific points of the appliance geometry (e.g., dimensional deviations and/or deformation can be calculated at each point on the appliance), over one or more regions of the appliance geometry (e.g., the average, maximum, and/or minimum deviation can be calculated per each region of the appliance), over the entirety of the appliance geometry (e.g., the average, maximum, and/or minimum deviation can be calculated over the entire appliance), or suitable combinations thereof.

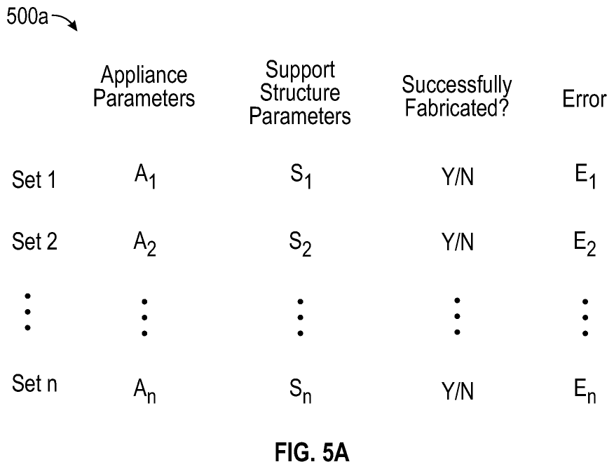

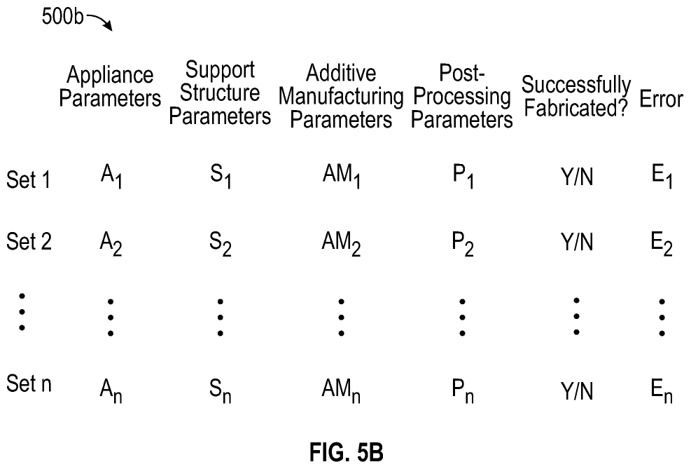

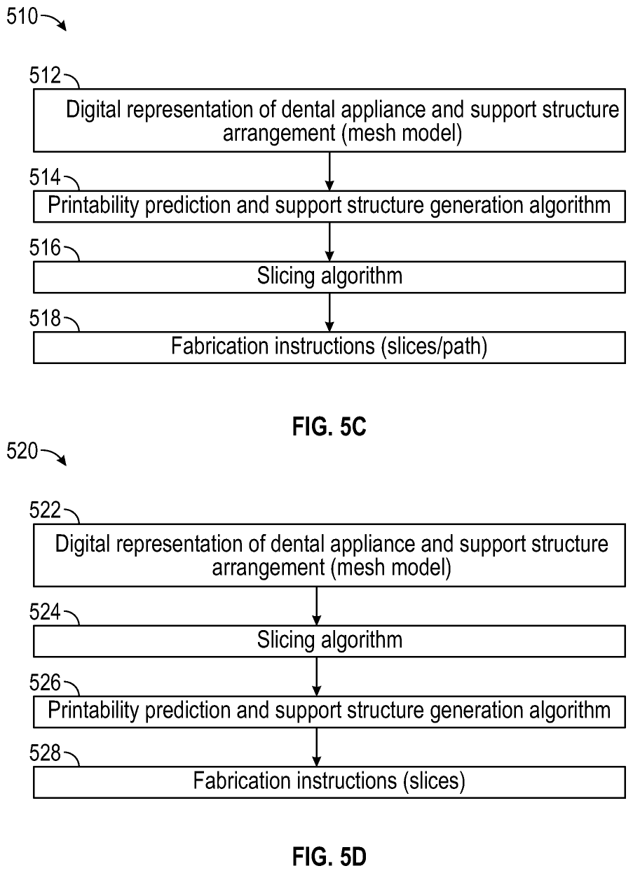

FIG. 5A illustrates a representative example of a training data set 500a that may be produced by the process of block 308 of FIG. 3, in accordance with embodiments of the present technology. The training data set 500a includes a plurality of data rows (e.g., Set 1, Set 2, . . . Set n), each data row corresponding to a particular dental appliance and support structure arrangement. Each data row (e.g., Set 1) includes a set of appliance parameters (e.g., A₁) representing the geometry of the appliance, a set of support structure parameters (e.g., S₁) representing the geometry of the support structure arrangement, a first outcome parameter indicating whether the dental appliance and support structure arrangement was successfully fabricated (e.g., “Y/N”), and a set of second outcome parameters quantifying the dimensional and/or force errors of the appliance (e.g., E₁). In some embodiments, each set of second outcome parameters (e.g., E₁) is represented as a high-dimensional vector containing the error information distributed along the surface and/or solid body of the appliance, or as a projection of such a vector to a lower-dimensional metric for easier interpretation and/or optimization. As described above, the error can include the mean, maximum, or minimum deviation between the actual and planned dimensions of the appliance, and/or the mean, maximum, or minimum deviation between the actual and planned forces produced by the appliance when worn on a patient's teeth.

FIG. 5B illustrates a representative example of another training data set 500b that may be produced by the process of block 308 of FIG. 3, in accordance with embodiments of the present technology. The training data set 500b is generally similar to the training data set 500a of FIG. 5A, except that the training data set 500b includes two additional parameters: a set of additive manufacturing parameters (e.g., AM₁) representing the parameters used during additive manufacturing of the dental appliance, and a set of post-processing parameters (e.g., P₁) representing the parameters used during post-processing of the dental appliance. The additive manufacturing parameters can include process type (e.g., stereolithography, digital light processing, selective laser sintering), curing time, grayscale level, printing speed, light intensity, minimum feature size, minimum layer height, print resolution, print unit shape, print directionality, print offset, an expected amount of overcuring and/or overbuild, packing density on the build platform (e.g., minimum, maximum, and/or average distance between neighboring objects; minimum, maximum, and/or average object density per unit area), etc. Optionally, the additive manufacturing parameters can include parameters of the precursor material used to fabricate the appliance, such as material type, rheological properties (e.g., viscosity), optical properties, light transmittance, light scattering, etc. The post-processing parameters can include the types of post-processing operations performed, such as centrifuging, washing, post-curing, etc. The post-processing parameters can also include conditions associated with the post-processing operations, such as temperature, applied forces, exposure to energy, exposure to solvents and/or other chemicals, etc.

Referring again to FIG. 3, at block 310, the training data set is used to train the support structure generation algorithm. The support structure algorithm can be or include at least one machine learning algorithm, such as a regression algorithm (e.g., ordinary least squares regression, linear regression, logistic regression, stepwise regression, multivariate adaptive regression splines, locally estimated scatterplot smoothing), an instance-based algorithm (e.g., k-nearest neighbor, learning vector quantization, self-organizing map, locally weighted learning), regularization algorithms (e.g., ridge regression, least absolute shrinkage and selection operator, elastic net, least-angle regression), a decision tree algorithm (e.g., Iterative Dichotomiser 3 (ID3), C4.5, C5.0, classification and regression trees, chi-squared automatic interaction detection, decision stump, M5), a Bayesian algorithm (e.g., naïve Bayes, Gaussian naïve Bayes, multinomial naïve Bayes, averaged one-dependence estimators, Bayesian belief networks, Bayesian networks, hidden Markov models, conditional random fields), a clustering algorithm (e.g., k-means, single-linkage clustering, k-medians, expectation maximization, hierarchical clustering, fuzzy clustering, density-based spatial clustering of applications with noise (DBSCAN), ordering points to identify cluster structure (OPTICS), non negative matrix factorization (NMF), latent Dirichlet allocation (LDA), Gaussian mixture model (GMM)), an association rule learning algorithm (e.g., apriori algorithm, equivalent class transformation (Eclat) algorithm, frequent pattern (FP) growth), an artificial neural network algorithm (e.g., perceptrons, neural networks, back-propagation, Hopfield networks, autoencoders, Boltzmann machines, restricted Boltzmann machines, spiking neural nets, radial basis function networks), a deep learning algorithm (e.g., deep Boltzmann machines, deep belief networks, convolutional neural networks, stacked auto-encoders), a dimensionality reduction algorithm (e.g., principle component analysis (PCA), independent component analysis (ICA), principle component regression (PCR), partial least squares regression (PLSR), Sammon mapping, multidimensional scaling, projection pursuit, linear discriminant analysis, mixture discriminant analysis, quadratic discriminant analysis, flexible discriminant analysis), an ensemble algorithm (e.g., boosting, bootstrapped aggregation, AdaBoost, blending, gradient boosting machines, gradient boosted regression trees, random forest), or suitable combinations thereof.

The training of the support generation algorithm can be performed using any suitable technique known to those of skill in art, including supervised learning, unsupervised learning, reinforcement learning, or suitable combinations thereof. For instance, the training data set can be divided into training, validation, and testing subsets to ensure a robust training process and evaluation. Multiple candidate support structure generation algorithms can be trained on the training subset, then tested on the validation subset to evaluate algorithm performance. Hyperparameter optimization techniques such as grid search or randomized search can be used to identify the most effective algorithm configurations.

In some embodiments, the support structure generation algorithm is trained to receive a digital representation of a geometry of a dental appliance, and to output a digital representation of a support structure arrangement for the dental appliance that is likely to produce a successful fabrication outcome. For instance, the support structure algorithm can be trained to receive a set of appliance parameters for a dental appliance (e.g., Aₓ), and to generate a set of support structure parameters for a support structure arrangement (e.g., Sₓ) that is predicted to successfully support the appliance during additive manufacturing (e.g., successfully fabricated=“Y”) and results in an appliance with little or no error in dimensions and/or forces (e.g., minimize Eₓ). As another example, the support structure algorithm can be trained to receive a digital representation of a dental appliance, and to generate a digital representation of a support structure arrangement that is predicted to successfully support the appliance during additive manufacturing (e.g., successfully fabricated=“Y”) and results in an appliance with little or no error in dimensions and/or forces (e.g., minimize Eₓ). In a further example, a support structure generation algorithm can be trained to receive a digital representation of a dental appliance together with a support structure arrangement for the dental appliance, and to output a modified digital representation in which the geometry of the dental appliance and/or support structure arrangement have been adjusted in a manner that is predicted to improve printability (e.g., successfully fabricated=“Y”) and results in an appliance with little or no error in dimensions and/or forces (e.g., minimize Eₓ). The trained support structure generation algorithm can then be used to determine support structure arrangements for dental appliances for implementing a treatment plan, as described further below.

FIG. 5C is a flow diagram illustrating a workflow 510 for generating and/or designing support structures using a machine learning algorithm, in accordance with embodiments of the present technology. The data input to the workflow 510 can be a digital representation of a dental appliance and support structure arrangement (block 512). The digital representation can be a 3D digital model of the dental appliance with the support structure arrangement, such as a mesh model. The digital representation can be input into a printability prediction and support structure generation algorithm (block 514). The algorithm can be a feature-based machine learning algorithm that analyzes the digital representation to identify features relevant to printability and support. The features can be identical or similar to the appliance parameters and/or support structure parameters described herein, such as local overhang angles, distance to the closest supporting point, radius of curvature, local shell thickness, local strut diameter, etc. The algorithm can generate structured data (e.g., parameterized data) representing the features. In some embodiments, the algorithm can predict printability and/or support issues based on the identified features. The algorithm can modify the digital representation according to the identified features and predicted printability and/or support issues to improve printability and accuracy of the appliance. The modifications can include, for example, changing a shape and/or size of a portion of the dental appliance, changing a shape and/or size of a portion of a support structure, adding a support structure, removing a support structure, changing a location of a support structure, or suitable combinations thereof.

Subsequently, the modified digital representation can be input into a slicing algorithm (block 516) that generates fabrication instructions (block 518) for additive manufacturing of the dental appliance and support structure arrangement. For instance, the slicing algorithm can generate a plurality of images corresponding to a plurality of cross-sections (e.g., layers) of the dental appliance and support structures for fabrication via a layer-by-layer additive manufacturing process. The pixels or voxels in the image can represent locations where energy is to be applied to a precursor material to form the respective cross-section, and optionally, the parameters of the applied energy (e.g., intensity, exposure time). The format of the fabrication instructions can vary depending on the type of additive manufacturing process used. For instance, in embodiments where the additive manufacturing process is a digital light processing (DLP) technique, the fabrication instructions can be a plurality of slices representing the distribution of energy to be applied by the DLP energy source to form each cross-section. In embodiments where the additive manufacturing process is a stereolithography (SLA) or selective laser sintering (SLS) technique, the fabrication instructions can define a path for the SLA or SLS energy source to apply energy to form each cross-section.

The printability prediction and support structure generation algorithm of block 514 can be trained using any suitable technique. In some embodiment, the training process uses training data generated from a plurality of coupons that incorporate typical features relevant to the dental appliances to be fabricated (e.g., aligners, retainer, etc.). The features of the coupons can be represented in a way that encompasses the range of variations that are likely to be encountered in real-world scenarios. In some embodiments, a set of approximately 12 to 30 coupons are designed and printed to generate training data. Moreover, training data can be generated from examples of actual dental appliances that are representative of typical real-world cases.

The coupons and/or appliances can be printed and scanned to generate digital files (e.g., high-fidelity STL files) to capture the nuances and variations that may occur during fabrication. The scan data can have sufficiently high resolution and accuracy to capture the relevant details of the printed coupons and/or appliances, in order to ensure high quality of the training data. Subsequently, the scan data can be aligned with the initial digital representations (e.g., CAD files) of the coupons and/or appliances to ensure consistency in feature identification. The scan data can be analyzed to identify and extract key features (e.g., appliance and/or support structure parameters), and to construct a structured data set that includes these features along with their corresponding print outcomes.

The structured data set can be used as the training data set for the algorithm. In some embodiments, the structured data set is divided into training, validation, and testing subsets to ensure a robust training process and algorithm evaluation. Optionally, multiple algorithms can be trained on the training subset and tested on the validation subset to assess performance. Hyperparameter optimization techniques (e.g., grid search, randomized search) can be employed to identify the most effective algorithm configurations.

FIG. 5D is a flow diagram illustrating a workflow 520 for generating and/or designing support structures using a machine learning algorithm, in accordance with embodiments of the present technology. The data input to the workflow 520 can be a digital representation of a dental appliance and support structure arrangement (block 522). The digital representation can be a 3D digital model of the dental appliance with the support structure arrangement, such as a mesh model. The digital representation can be input into a slicing algorithm that generates fabrication instructions for additive manufacturing of the dental appliance and support structure arrangement (block 524). For instance, the slicing algorithm can generate a plurality of images corresponding to a plurality of cross-sections (e.g., layers) of the dental appliance and support structures for fabrication via a layer-by-layer additive manufacturing process. The pixels or voxels in the image can represent locations where energy is to be applied to a precursor material to form the respective cross-section, and optionally, the parameters of the applied energy (e.g., intensity, exposure time).

The images produced by the slicing algorithm can be input into a printability prediction and support structure generation algorithm (block 526). The algorithm can be a convolutional neural network (CNN) that analyzes the pixel or voxel space in the images to optimize for printability. The output of the algorithm can be a set of fabrication instructions (e.g., slices) that have been optimized to improve printability of the dental appliance and support structures during manufacturing (block 528). In some embodiments, the algorithm is a CNN-based deformation prediction and compensation model that utilizes at least one physics-based convolutional kernel to integrate the physical principles involved in additive manufacturing (e.g., light absorption, light scattering, curing kinetics, diffusion, surface tension, thermal conductivity, heat transfer, phase transitions, etc.) into the algorithm architecture, thereby enhancing predictive accuracy. Alternatively or in combination, the CNN can be a deep CNN (DCNN). The algorithm can process the input images through the CNN to generate visualized outcomes of the additive manufacturing process, including predicting potential deformations and/or inaccuracies. In some embodiments, the algorithm can modify the images based on the predicted outcomes to improve printability and accuracy of the appliance. The modifications can include, for example, changing a shape and/or size of a portion of the dental appliance, changing a shape and/or size of a portion of a support structure, adding a support structure, removing a support structure, changing a location of a support structure, or suitable combinations thereof.

The printability prediction and support structure generation algorithm of block 526 can be trained using any suitable technique. In some embodiment, the training process uses training data generated from a plurality of coupons that incorporate typical features relevant to the dental appliances to be fabricated (e.g., aligners, retainer, etc.). The features of the coupons can be represented in a way that encompasses the range of variations that are likely to be encountered in real-world scenarios. In some embodiments, a set of coupons are designed and printed to generate training data. The number of coupons can depend on the type of algorithm, e.g., 2 to 5 coupons may be sufficient for training a CNN using a physics-based convolutional kernel, while 6 to 20 coupons may be sufficient for training a DCNN. Moreover, training data can be generated from examples of actual dental appliances that are representative of typical real-world cases.

The coupons and/or appliances can be printed and scanned to generate digital files (e.g., high-fidelity STL files) to capture the nuances and variations that may occur during fabrication. The scan data can have sufficiently high resolution and accuracy to capture the relevant details of the printed coupons and/or appliances, in order to ensure high quality of the training data. The scan data can then be compared to the output of the CNN. In embodiments where the algorithm uses a CNN with a physics-based convolutional kernel, the convolutional kernel can be refined and tuned based on the comparison results, thus allowing for iterative improvements until the predicted outcomes from the CNN align closely with the actual printing results. In embodiments where the algorithm uses a DCNN, the scan data can be sliced, voxelized, and converted into 3D tensors suitable for processing by the DCNN. The tensors can be registered with tensors generated from the initial digital representations (e.g., CAD slices) of the coupons and/or appliances, to ensure that the DCNN is trained on accurately paired data. This approach allows the DCNN to learn the correspondences between the intended object geometry and the actual geometry after manufacturing.

Referring again to FIG. 3, at optional block 312, a library of support structure arrangements (“support structure library”) can be generated. The library can include a plurality of different support structure arrangements that have been determined to be feasible for supporting different appliance geometries. In some embodiments, the support structure generation algorithm is used to recognize categories or clusters of support structure arrangements that are likely to produce successful outcomes (e.g., the dental appliance is successfully fabricated with the desired degree of dimensional accuracy). Alternatively or in combination, the support structure library of block 312 can be generated based on the experimental data of block 302 and/or the simulation data produced in block 304. For instance, support structure arrangements that have been validated through experiments and/or simulations can be added to the support structure library.

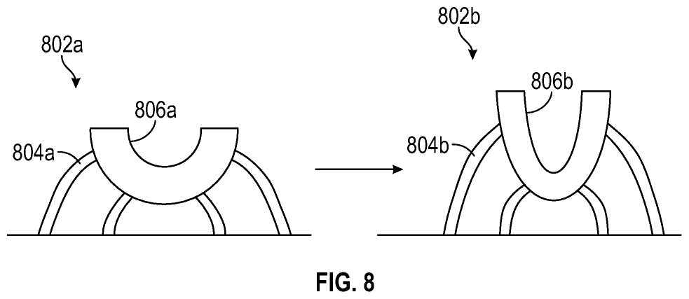

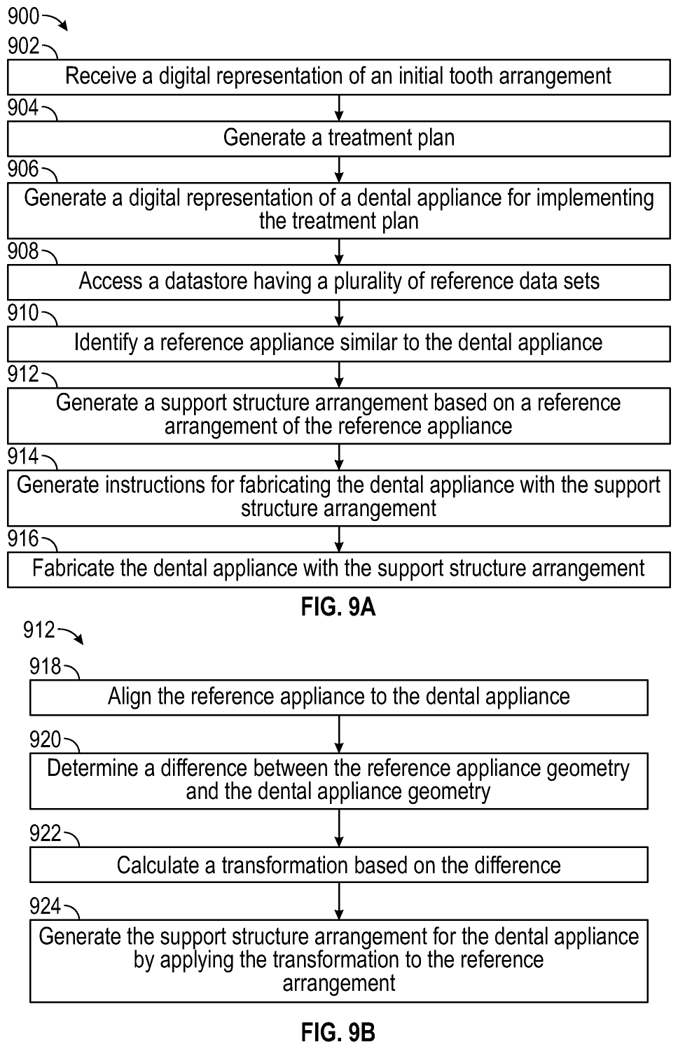

The support structure library can provide working examples that can be used to determine support structure arrangements for future dental appliances. In some embodiments, the support structure arrangements in the library are used directly for future dental appliances, without modifications. In other embodiments, the support structure arrangements in the library can be customized and/or otherwise modified for each dental appliance, such as using a transformation as described below in connection with FIGS. 8-9B.

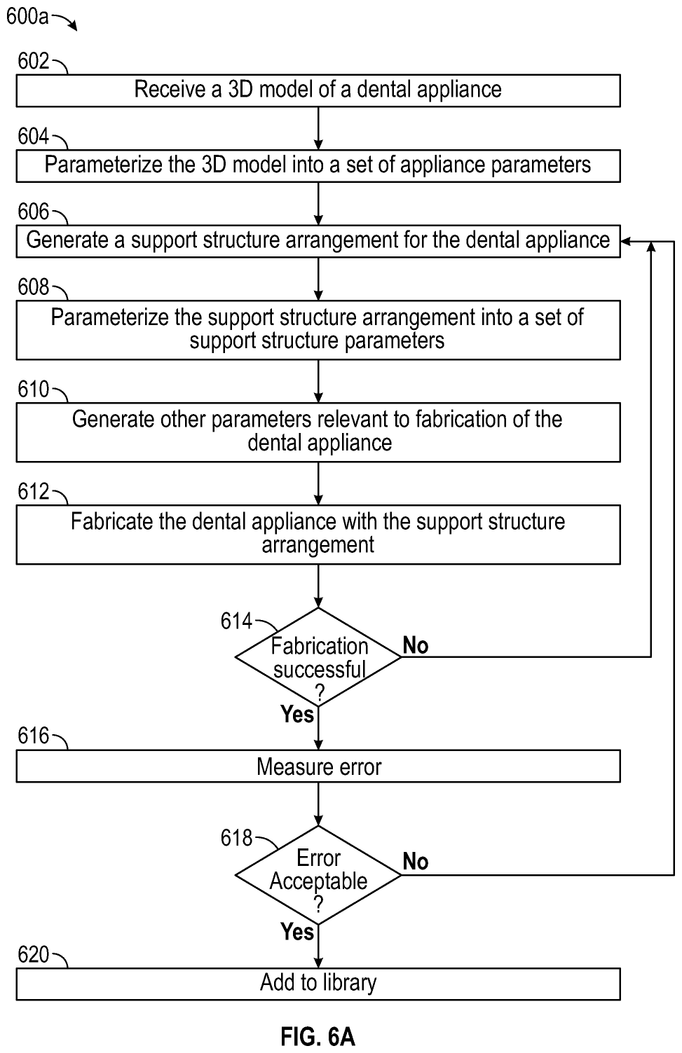

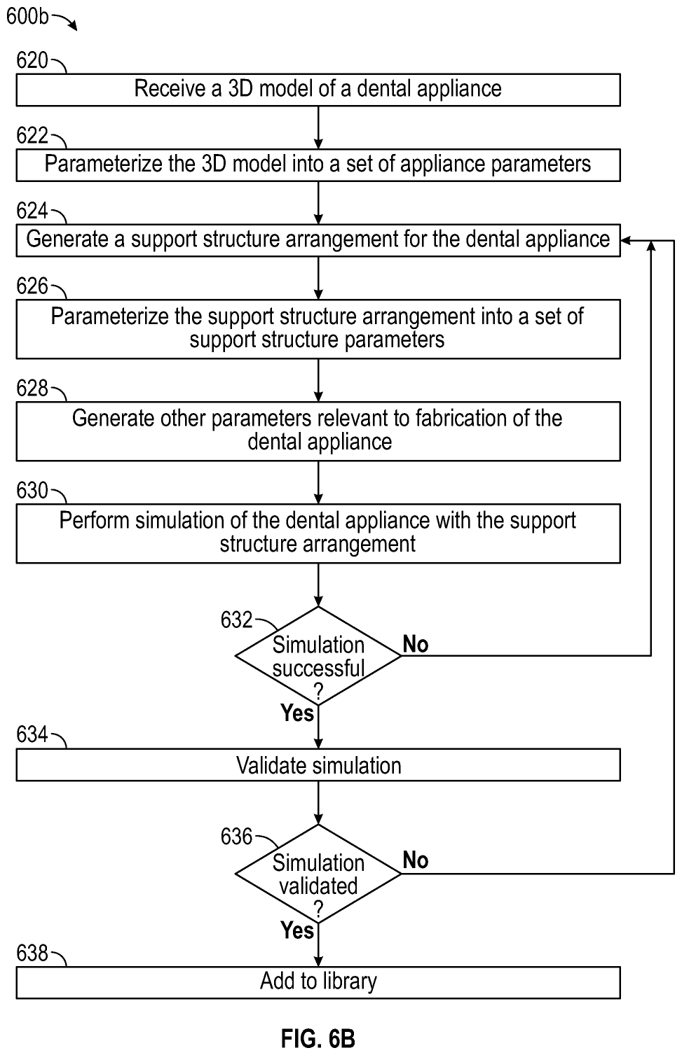

FIG. 6A is a flow diagram illustrating a method 600a for validating a support structure design via experimental testing, in accordance with embodiments of the present technology. The method 600a can be used to produce training data for a support structure generation algorithm (e.g., as described in connection with block 308 of FIG. 3) and/or validated examples for a support structure library (e.g., as described in connection with block 312 of FIG. 3). The method 600a can be performed using any suitable system or device. In some embodiments, some or all of the processes of the method 600a are implemented as computer-readable instructions (e.g., program code) that are configured to be executed by one or more processors of a computing device.

The method 600a begins at block 602 with receiving a 3D model of a dental appliance. The dental appliance can be an aligner, palatal expander, retainer, attachment placement device, attachment, distalizer, oral sleep apnea appliance, mouth guard, etc. For example, the dental appliance can include a shell having a plurality of teeth-receiving cavities configured to reposition a patient's teeth in accordance with a treatment plan, as described elsewhere herein. The 3D model can be a point cloud model, surface model, mesh model, or other digital representation of the 3D geometry of the dental appliance.

At block 604, the method 600a can include parameterizing the 3D model of the dental appliance into a set of appliance parameters. The appliance parameters can be numerical values representing one or more of the following features of the dental appliance: curvature, surface normal, distance to occlusal surface, appliance size, appliance complexity, and/or tooth centroid. The appliance parameters can be computed at one or more specific points of the appliance geometry, over one or more regions of the appliance geometry, over the entirety of the appliance geometry, or suitable combinations thereof. In other embodiments, the parameterization process of block 604 is optional and may be omitted.

At block 606, the method 600a can include generating a support structure arrangement for the dental appliance. The support structure arrangement can be determined manually by a human operator, automatically using a software algorithm, or suitable combinations thereof. For example, an initial support structure arrangement can be automatically generated by slicer software associated with an additive manufacturing system. As another example, a previously validated support structure arrangement can be used as the initial support structure arrangement. Subsequently, a technician can review and modify the initial support structure arrangement to produce a final support structure arrangement for testing. The support structure arrangement can be provided as a 3D model, such as a point cloud model, surface model, mesh model, or other digital representation of the 3D geometry of the support structure arrangement. Optionally, the 3D model of the support structure arrangement can be merged with or be provided as part of the 3D model of the dental appliance.

At block 608, the method 600a can include parameterizing the support structure arrangement into a plurality of support structure parameters. The support structure parameters can be numerical values representing one or more of the following features of the support structure arrangement: diameter, height, density, conic profile, overhang, and/or turn/bend radius. The support structure parameters can be computed for individual support structures in the arrangement, for one or more subsets of support structures in the arrangement, for all the support structures in the arrangement, or suitable combinations thereof. In other embodiments, the parameterization process of block 608 is optional and may be omitted.

At block 610, the method 600a can optionally include generating other parameters that are relevant to fabrication of the dental appliance. The other parameters can include, for example, a set of additive manufacturing parameters corresponding to an additive manufacturing process for fabricating the dental appliance, such as process type, curing time, grayscale level, printing speed, light intensity, minimum feature size, minimum layer height, print resolution, print unit shape, print directionality, print offset, an expected amount of overcuring and/or overbuild, packing density on the build platform, precursor material properties (e.g., material type, rheological properties, optical properties, light transmittance, light scattering), etc. The other parameters can alternatively or additionally include a set of post-processing parameters corresponding to one or more post-processing operations for fabricating the dental appliance, such as process type, temperature, applied forces, exposure to energy, exposure to solvents and/or other chemicals, etc. In other embodiments, the process of block 609 may be omitted.

At block 612, the method 600a can include fabricating the dental appliance with the support structure arrangement using an additive manufacturing process. Examples of additive manufacturing processes that may be used are described elsewhere herein. Optionally, the process of block 612 can include performing one or more post-processing operations after the additive manufacturing process. Examples of post-processing operations that may be used are described elsewhere herein.

At block 614, the method 600a can include determining whether the dental appliance with the support structure arrangement was successfully fabricated. The fabrication process can be considered successful if the entire dental appliance was printed, remained attached to the build platform, and/or did not collapse during or after printing and/or during or after post-processing. If the fabrication process was not successful, the method 600a can optionally return to block 606 with revising the support structure arrangement for the dental appliance. In such embodiments, information regarding the types and/or locations of print failure can be used as feedback to revise the support structure arrangement.

If the fabrication process was successful, the method 600a can continue to block 616 with measuring an error in the fabricated dental appliance using experimental testing. For instance, the error can include the dimensional error of the dental appliance. The dimensional error can be experimentally determined by generating a digital representation of the fabricated appliance (e.g., by scanning), then comparing the digital representation with the 3D model of block 602. As another example, the error can include the force error of the dental appliance. In some embodiments, the dental appliance is designed to apply a particular force system to the patient's teeth when worn. The force error can be experimentally determined by measuring the forces produced by the fabricated appliance (e.g., via three-point bending tests, stress relaxation tests, tensile loading tests, etc.), then comparing the measured forces to one or more forces specified by the planned force system.

At block 618, the method 600a can include determining whether the measured error was acceptable. The process of block 618 can include, for example, comparing the maximum, minimum, and/or average dimensional and/or force error to a corresponding threshold value. The error can be considered acceptable if it is less than or equal to the threshold value, and unacceptable if it is greater than the threshold value. The appropriate threshold values can be selected based on the type of appliance, the type of treatment, clinical data, data from previous experimental testing, and/or any other relevant consideration.

In some embodiments, if the error was unacceptable, the method 600a can optionally return to block 606 with revising the support structure arrangement for the dental appliance. In such embodiments, information regarding the magnitude and/or locations of the errors can be used as feedback to revise the support structure arrangement. If the error was acceptable, at block 620, the method 600a can optionally include adding the support structure arrangement to a library of validated support structures, such as the support structure library of block 312 of FIG. 3.

The outputs of the method 600a can be used to generate training data for a support structure generation algorithm (e.g., as described in connection with block 308 of FIG. 3). For instance, the training data can include the appliance parameters of block 604, the support structure parameters of block 608, the other parameters of block 610, the fabrication outcome of block 614, the measured error of block 616, and/or the acceptability of the error of block 618. In some embodiments, the method 600a is performed multiple times for different appliance geometries and/or support structure arrangements to provide representative samples of the design space for training and optimization purposes. The appliance parameters, support structure parameters, and/or other parameters to be sampled can be determined via an acquisition function (e.g., a Bayesian optimization scheme with Gaussian process regression), with more weight given to regions of the design space where data is not yet available.

Although the method 600a is described in connection with fabrication and experimental testing of a dental appliance, in some embodiments, the method 600ba can alternatively or additionally include fabrication and testing of a reference object (e.g., a coupon). The reference object can have a standardized geometry, such a block, tube, arch, etc. Optionally, the reference object can include appliance features that are typically present in the dental appliance to be fabricated. The appliance features can be represented in the reference object in a manner that encompasses the range of variations that are likely to be present in actual dental appliances, such as different sizes, shapes, locations, etc. Accordingly, the reference objects can be used to generate experimental data for various feature combinations and/or complexities.

FIG. 6B is a flow diagram illustrating a method 600b for validating a support structure design via simulation, in accordance with embodiments of the present technology. The method 600b can be used to produce training data for a support structure generation algorithm (e.g., as described in connection with block 308 of FIG. 3) and/or validated examples for a support structure library (e.g., as described in connection with block 312 of FIG. 3). The method 600b can be performed using any suitable system or device. In some embodiments, some or all of the processes of the method 600b are implemented as computer-readable instructions (e.g., program code) that are configured to be executed by one or more processors of a computing device.

The method 600b can include receiving a 3D model of a dental appliance (block 620), parameterizing the 3D model of the dental appliance into a set of appliance parameters (block 622), generating a support structure arrangement for the dental appliance (block 624), parameterizing the support structure arrangement into a plurality of support structure parameters (block 626), and/or generating other parameters relevant to fabrication of the dental appliance (block 628). The processes of blocks 620-628 can be identical or generally similar to the processes of blocks 602-610, respectively, of the method 600a of FIG. 6A.

At block 630, the method 600b can include performing a simulation of the dental appliance with the support structure arrangement. The simulation can use FEM, reduced order FEM, or any other suitable approach for virtually evaluating the performance of the dental appliance and support structure arrangement. For example, the simulation can determine the stress distribution, strain distribution, deformation, and/or displacement of the dental appliance and/or support structures when exposed to loading (e.g., due to gravity, centrifugation, forces applied during additive manufacturing, etc.). The simulation can be performed with respect to any suitable stage in the fabrication procedure, such as during and/or after additive manufacturing; and/or before, during, and/or after post-processing.

At block 632, the method 600b can include determining whether the results of the simulation were successful. The simulation results can be considered successful if the simulated behavior of the dental appliance and support structure arrangement met certain criteria. For example, the performance criteria can include whether the simulated stress in the appliance and/or support structure arrangement exceeded a predetermined threshold (e.g., a threshold corresponding to plastic deformation, fracture, collapse, or other failure mode). As another example, the performance criteria can include whether the simulated deformation and/or displacement in the appliance and/or support structure arrangement resulted in significant deviations between the actual and planned geometries.

If the simulation was not successful, the method 600b can optionally return to block 624 with revising the support structure arrangement for the dental appliance. In such embodiments, information regarding the types and/or locations of simulation failures can be used as feedback to revise the support structure arrangement.

If the simulation was successful, the method 600b can optionally continue to block 634 with validating the simulation results via experimental testing. At block 636, the method 600b can include determining whether the simulation results were validated. The process of block 636 can include, for example, comparing the maximum, minimum, and/or average dimensional and/or force error to a corresponding threshold value. The error can be considered acceptable if it is less than or equal to the threshold value, and unacceptable if it is greater than the threshold value. The appropriate threshold values can be selected based on the type of appliance, the type of treatment, clinical data, data from previous experimental testing, and/or any other relevant consideration.

In some embodiments, if the error was unacceptable, the method 600b can optionally return to block 624 with revising the support structure arrangement for the dental appliance. In such embodiments, information regarding the magnitude and/or locations of the errors can be used as feedback to revise the support structure arrangement. If the error was acceptable, at block 638, the method 600b can optionally include adding the support structure arrangement to a library of validated support structures, such as the support structure library of block 312 of FIG. 3.

The outputs of the method 600b can be used to generate training data for a support structure generation algorithm (e.g., as described in connection with block 308 of FIG. 3). For instance, the training data can include the appliance parameters of block 622, the support structure parameters of block 626, the other parameters of block 628, the simulation outcome of block 632, and/or the validation outcome of block 636. In some embodiments, only the outputs that are associated with validated simulations are used for generating training data. Alternatively or in combination, outputs that are sufficiently close to validated simulations (e.g., the appliance, support structure, and/or other parameters are sufficiently close to the parameters of a validated simulation) can be used to generate training data. Optionally, outputs can be used to generate training data, regardless of whether the simulation was validated.

In some embodiments, the method 600b is performed multiple times for different appliance geometries and/or support structure arrangements to provide representative samples of the design space for training and optimization purposes. The appliance parameters, support structure parameters, and/or other parameters to be sampled can be determined via an acquisition function (e.g., a Bayesian optimization scheme with Gaussian process regression), with more weight given to regions of the design space where data is not yet available.

Although the method 600b is described in connection with simulation and of a dental appliance, in some embodiments, the method 600b can alternatively or additionally include simulation of a reference object (e.g., a coupon). The reference object can have a standardized geometry, such a block, tube, arch, etc. Optionally, the reference object can include appliance features that are typically present in the dental appliance to be fabricated. The appliance features can be represented in the reference object in a manner that encompasses the range of variations that are likely to be present in actual dental appliances, such as different sizes, shapes, locations, etc. Accordingly, the reference objects can be used to generate simulation data for various feature combinations and/or complexities.

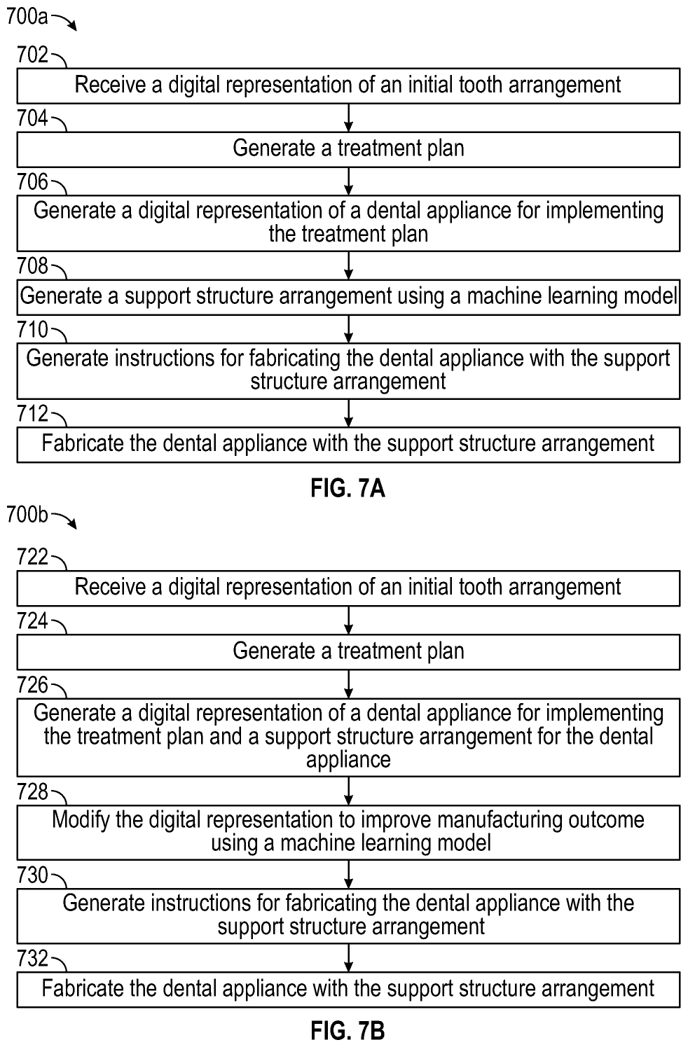

FIG. 7A is a flow diagram illustrating a method 700a for designing and fabricating dental appliances with support structures, in accordance with embodiments of the present technology. The method 700a can be used to generate any embodiment of the dental appliances and support structures described herein (e.g., the embodiments of FIGS. 2A-2G).

The method 700a can begin at block 702 with receiving a digital representation of an initial tooth arrangement. The digital representation can be a 3D dental model (e.g., a point cloud, mesh model, surface model), and can be generated from image data of the patient's teeth, as previously described in connection with blocks 102 and 104 of FIG. 1.

At block 704, the method 700a can include generating a treatment plan. The treatment plan can be manually generated by a human operator, automatically generated using software algorithms, or suitable combinations thereof. In some embodiments, the treatment planning process involves determining a target tooth arrangement for the patient's teeth and a plurality of treatment stages (e.g., intermediate tooth arrangements) to achieve the target tooth arrangement, as described above in connection with block 106 of FIG. 1.

At block 706, the method 700a can include generating a digital representation of a dental appliance for implementing the treatment plan. For instance, the dental appliance can include a shell having a plurality of teeth-receiving cavities for repositioning the patient's teeth from a first arrangement (e.g., the initial arrangement or an intermediate arrangement) toward a second arrangement (e.g., an intermediate arrangement or the final arrangement). The digital representation of the appliance can be a point cloud, mesh model, surface model, parametric model, non-parametric model, or any other digital model depicting the size, shape, and features of the appliance, as described above in connection with block 110 of FIG. 1. In some embodiments, the process of block 706 includes generating a plurality of digital representations for a plurality of different dental appliances, with each dental appliance configured to implement a respective treatment stage of the treatment plan.

At block 708, the method 700a can continue with generating a support structure arrangement using a machine learning model. As previously described with respect to block 112 of FIG. 1, the support structure arrangement can be configured to support the dental appliance and/or prevent deformation during additive manufacturing and/or post-processing of the dental appliance. The support structure arrangement can include any of the features discussed above in connection with FIGS. 2A-2G. In embodiments where multiple dental appliances are generated in block 706, the process of block 708 can include generating a support structure arrangement for each dental appliance.

The machine learning model can be trained in accordance with the techniques described in connection with FIGS. 3-6B. For example, the machine learning model can be trained to receive an input data set, such as a set of appliance parameters generated from the digital representation of the dental appliance, and can be trained to output a set of support structure parameters representing a support structure arrangement that is likely to successfully support the dental appliance during additive manufacturing and/or post-processing. The training data for the machine learning model can include experimental data, simulation data, or suitable combinations thereof. In some embodiments, the training data includes appliance data representing geometries for a plurality of dental appliances, support structure data representing geometries of a plurality of support structure arrangements, and outcome data representing outcomes of fabricating the dental appliances with their respective support structure arrangements. Alternatively or in combination, the training data can include data representing geometries of a plurality of reference objects (e.g., coupons), and outcome data representing outcomes of fabricating the reference objects.

At block 710, the method 700a can include generating instructions for fabricating the dental appliance with the support structure arrangement. In some embodiments, the output of the machine learning model is a set of support structure parameters, and the process of block 710 involves converting the support structure parameters into a format suitable for controlling an additive manufacturing system. For example, the support structure parameters can be used to generate a 3D digital representation of the support structures arrangement, such as a point cloud, mesh model, surface model, etc. The instructions can be a digital file of the 3D digital representation (e.g., a CAD file, STL file, OBJ file, AMF file, 3MF file) and/or a toolpath file generated from the 3D digital representation (e.g., a G-code file), as previously described in connection with block 114 of FIG. 1.

At block 712, the method 700a can include fabricating the dental appliance with the support structure arrangement. The fabrication can be performed using an additive manufacturing technique, such as any of the embodiments described herein. The fabrication process can include producing the dental appliance and support structure arrangement via additive manufacturing, then post-processing the dental appliance (e.g., post-curing, cleaning, removing support structures), as described above in connection with block 116 of FIG. 1.

The method 700a can be performed using any suitable system or device. In some embodiments, some or all of the processes of the method 700a are implemented as computer-readable instructions (e.g., program code) that are configured to be executed by one or more processors of a computing device. Some or all of the processes of the method 700a can be performed by different systems or devices. For example, the processes of blocks 702, 704, and/or 706 can be performed by a treatment planning system; the process of block 708 can be performed by an appliance design system; and/or the processes of blocks 710 and/or 712 can be performed by a fabrication system.

FIG. 7B is a flow diagram illustrating a method 700b for designing and fabricating dental appliances with support structures, in accordance with embodiments of the present technology. The method 700b can be used to generate any embodiment of the dental appliances and support structures described herein (e.g., the embodiments of FIGS. 2A-2G).

The method 700b can begin at block 722 with receiving a digital representation of an initial tooth arrangement. The digital representation can be a 3D dental model (e.g., a point cloud, mesh model, surface model), and can be generated from image data of the patient's teeth, as previously described in connection with blocks 102 and 104 of FIG. 1.

At block 724, the method 700b can include generating a treatment plan. The treatment plan can be manually generated by a human operator, automatically generated using software algorithms, or suitable combinations thereof. In some embodiments, the treatment planning process involves determining a target tooth arrangement for the patient's teeth and a plurality of treatment stages (e.g., intermediate tooth arrangements) to achieve the target tooth arrangement, as described above in connection with block 106 of FIG. 1.

At block 726, the method 700b can include generating a digital representation of a dental appliance for implementing the treatment plan together with a support structure arrangement. For instance, the dental appliance can include a shell having a plurality of teeth-receiving cavities for repositioning the patient's teeth from a first arrangement (e.g., the initial arrangement or an intermediate arrangement) toward a second arrangement (e.g., an intermediate arrangement or the final arrangement). The digital representation of the appliance can be a point cloud, mesh model, surface model, parametric model, non-parametric model, or any other digital model depicting the size, shape, and features of the appliance, as described above in connection with block 110 of FIG. 1. In some embodiments, the process of block 726 includes generating a plurality of digital representations for a plurality of different dental appliances, with each dental appliance configured to implement a respective treatment stage of the treatment plan.

As previously described with respect to block 112 of FIG. 1, the support structure arrangement can be configured to support the dental appliance and/or prevent deformation during additive manufacturing and/or post-processing of the dental appliance. The support structure arrangement can include any of the features discussed above in connection with FIGS. 2A-2G. In embodiments where multiple dental appliances are generated in block 726, a support structure arrangement can be generated for each dental appliance.

At block 728, the method 700b can continue with modifying the digital representation to improve a predicted manufacturing outcome using a machine learning model. The machine learning model can be trained in accordance with the techniques described in connection with FIGS. 3-6B. For example, the machine learning model can be trained to receive the digital representation of the dental appliance and support structure arrangement (e.g., a mesh model of the dental appliance and support structure arrangement, and/or a plurality of slices generated from the mesh model) to predict the manufacturing outcome with the dental appliance and support structure arrangement (e.g., whether there are certain locations, features, etc., that are likely to exhibit printability issues and/or deform during additive manufacturing and/or post-processing), and to output a modified digital representation (e.g., a modified mesh model and/or a plurality of modified slices) in which the dental appliance and/or support structure arrangement have been modified to increase the likelihood that the dental appliance will be successfully fabricated (e.g., the appliance prints successfully and has sufficient dimensional accuracy). The training data for the machine learning model can include experimental data, simulation data, or suitable combinations thereof. In some embodiments, the training data includes appliance data representing geometries for a plurality of dental appliances, support structure data representing geometries of a plurality of support structure arrangements, and outcome data representing outcomes of fabricating the dental appliances with their respective support structure arrangements. Alternatively or in combination, the training data can include data representing geometries of a plurality of reference objects (e.g., coupons), and outcome data representing outcomes of fabricating the reference objects.

At block 730, the method 700b can include generating instructions for fabricating the dental appliance with the support structure arrangement, based on the modified digital representation. The process of block 730 involves converting the modified digital representation into a format suitable for controlling an additive manufacturing system. For example, the instructions can be a digital file of the modified digital representation (e.g., a CAD file, STL file, OBJ file, AMF file, 3MF file) and/or a toolpath file generated from the modified digital representation (e.g., a G-code file), as previously described in connection with block 114 of FIG. 1.

At block 732, the method 700b can include fabricating the dental appliance with the support structure arrangement. The fabrication can be performed using an additive manufacturing technique, such as any of the embodiments described herein. The fabrication process can include producing the dental appliance and support structure arrangement via additive manufacturing, then post-processing the dental appliance (e.g., post-curing, cleaning, removing support structures), as described above in connection with block 116 of FIG. 1.

The method 700b can be performed using any suitable system or device. In some embodiments, some or all of the processes of the method 700b are implemented as computer-readable instructions (e.g., program code) that are configured to be executed by one or more processors of a computing device. Some or all of the processes of the method 700b can be performed by different systems or devices. For example, the processes of blocks 722 and/or 724 can be performed by a treatment planning system; the process of blocks 726 and/or 728 can be performed by an appliance design system; and/or the processes of blocks 730 and/or 732 can be performed by a fabrication system.

FIG. 8 is a partially schematic diagram illustrating a method for using a reference support structure arrangement (“reference arrangement 802a”) to generate a new support structure arrangement (“new arrangement 802b), in accordance with embodiments of the present technology. The reference arrangement 802a can include a plurality of first support structures 804a configured to support a first dental appliance 806a (or other object). In some embodiments, the first support structures 804a of the reference arrangement 802a have been previously validated (e.g., via experimental testing and/or simulation, as described in connection with FIGS. 6A and 6B) or are otherwise considered suitable for supporting the first dental appliance 806a during fabrication (e.g., additive manufacturing and/or post-processing). For instance, the reference arrangement 802a can be one of a plurality of working examples of a support structure library (e.g., the support structure library of block 312 of FIG. 3.).

The reference arrangement 802a can be used to generate a new arrangement 802b for supporting a second dental appliance 806b. As shown in FIG. 8, the second dental appliance 806b can have a different geometry than the first dental appliance 806a, such as a different shape, size, thickness, etc. In some embodiments, the first and second dental appliances 806a, 806b can have a generally similar base geometry, but with variations based on the particular patient to be treated and/or the particular treatment to be applied by the appliance. For instance, the first and second dental appliances 806a, 806b can each include a shell having a plurality of teeth-receiving cavities, but can differ from each other with respect to the shape of the overall arch form, the shapes of the teeth-receiving cavities, the thickness distribution of the shell, inclusion of other appliance components (e.g., attachment wells, ridges, bubbles, palatal expansion components), etc.

The new arrangement 802b can include a plurality of second support structures 804b that are customized to the geometry of the second dental appliance 806b. In some embodiments, the second support structures 804b are generated by transforming (e.g., morphing) the first support structures 804a to accommodate the geometry of the second dental appliance 806b. The transformation can include any of the following changes: a change in dimension (e.g., length, width, thickness, diameter) of at least one support structure, a change in shape (e.g., curvature, bend radius, cross-sectional shape) of at least one support structure, a change in support structure type, a change in location of at least one support structure, a change in support structure density at one or more appliance regions, a change in the total number of support structures, or suitable combinations thereof. In some embodiments, the number of the first support structures 804a remains the same, but the geometries are modified to generate the second support structures 804b. Alternatively, both the number and geometries of the first support structures 804a can be changed to generate the second support structures 804b.

The transformation can be determined based on the geometries of the first dental appliance 806a and the second dental appliance 806b. For instance, the geometry of the first dental appliance 806a (A₁) can be compared to the geometry of the second dental appliance 806b (A₂) in order to determine a transform function (T) that morphs the geometry of the first dental appliance 806a into the geometry of the second dental appliance 806b, such that A₂=T(A₁). The transform function can be determined using mathematical techniques, as described further below. The transform function can then be applied to the geometry of the first support structures 804a (S₁) to generate the geometry of the second support structures 804b (S₂), such that S₂=T(S₁).

In some embodiments, the transformation is applied to the entirety of the first support structures 804a. In other embodiments, the transformation can be applied to selected regions of the first support structures 804a, such as the connection regions of the first support structures 804a that are attached to the first dental appliance 806a, since those are the regions that may be most likely to be affected by changes in appliance geometry.

FIG. 9A is a flow diagram illustrating a method 900 for designing and fabricating dental appliances with support structures, in accordance with embodiments of the present technology. The method 900 can be used to generate any embodiment of the dental appliances and support structures described herein (e.g., the embodiments of FIGS. 2A-2G).

The method 900 can begin at block 902 with receiving a digital representation of an initial tooth arrangement. The digital representation can be a 3D dental model (e.g., a point cloud, mesh model, surface model), and can be generated from image data of the patient's teeth, as previously described in connection with blocks 102 and 104 of FIG. 1.

At block 904, the method 900 can include generating a treatment plan. The treatment plan can be manually generated by a human operator, automatically generated using software algorithms, or suitable combinations thereof. In some embodiments, the treatment planning process involves determining a target tooth arrangement for the patient's teeth and a plurality of treatment stages (e.g., intermediate tooth arrangements) to achieve the target tooth arrangement, as described above in connection with block 106 of FIG. 1.

At block 906, the method 900 can include generating a digital representation of a dental appliance for implementing the treatment plan. For instance, the dental appliance can include a shell having a plurality of teeth-receiving cavities for repositioning the patient's teeth from a first arrangement (e.g., the initial arrangement or an intermediate arrangement) toward a second arrangement (e.g., an intermediate arrangement or the final arrangement). The digital representation of the appliance can be a point cloud, mesh model, surface model, parametric model, non-parametric model, or any other digital model depicting the size, shape, and features of the appliance, as described above in connection with block 110 of FIG. 1. In some embodiments, the process of block 906 includes generating a plurality of digital representations for a plurality of different dental appliances, with each dental appliance configured to implement a respective treatment stage of the treatment plan.

At block 908, the method 900 can continue with accessing a datastore having a plurality of reference data sets. Each reference data set can include a digital representation of a dental appliance (“reference appliance”) and a digital representation of a support structure arrangement (“reference arrangement”) for that dental appliance. For example, the datastore can be a support structure library including a plurality of reference arrangements that have been validated or otherwise deemed to be feasible working examples, as previously described with respect to block 312 of FIG. 3.

At block 910, the method 900 can include identifying a reference appliance similar to the dental appliance. For instance, the reference appliance can have a geometry similar to the geometry of the dental appliance, such as a similar arch form (e.g., tapered, square, ovoid), thickness distribution, size, etc. Optionally, the reference appliance can be larger or smaller than the dental appliance, but can be scaled to have a similar size as the dental appliance. In some embodiments, the reference appliance is the same or similar appliance type as the dental appliance (e.g., if the dental appliance is a palatal expander, the reference appliance is also a palatal expander).

In some embodiments, the process of block 910 involves comparing the dental appliance to a plurality of different reference appliances to identify the reference appliance that is most similar to the dental appliance. This approach can involve comparing the 3D geometries of the dental appliance and reference appliances, such as by using a registration algorithm to align a 3D digital representation of the dental appliance with a 3D digital representation of each of the reference appliances, and then determining the differences (e.g., distances) between the digital representations. Alternatively or in combination, the comparison can be performed by parameterizing the dental appliance and reference appliances into respective sets of geometric parameters as described elsewhere herein, and then computing a similarity score between the sets of geometric parameters (e.g., using a minimization algorithm).

At block 912, the method 900 can include generating a support structure arrangement for the dental appliance, based on a reference arrangement of the reference appliance. The reference arrangement can be a set of support structures that have been validated or are otherwise expected to successfully support the reference appliance during fabrication. The support structure arrangement for the dental appliance can be generated using a transformation algorithm that modifies the reference arrangement to accommodate the geometry of the dental appliance (e.g., as described above in connection with FIG. 8). For instance, the transformation algorithm can modify a dimension (e.g., length, width, thickness, diameter) of at least one support structure, a shape (e.g., curvature, bend radius, cross-sectional shape) of at least one support structure, a type of at least one support structure, a location of at least one support structure, support structure density at one or more appliance regions, the total number of support structures, or suitable combinations thereof.

FIG. 9B is a flow diagram illustrating an example of a support structure generation process of block 912, in accordance with embodiments of the present technology. At block 918, the reference appliance is aligned to the dental appliance. For instance, a registration algorithm can be used to align a 3D digital representation of the reference appliance to a 3D digital representation of the dental appliance. The 3D digital representations can be point clouds, mesh models, surface models, or any other model type that depicts the geometries of the reference appliance and the dental appliance. Optionally, the process of block 918 can involve normalizing (e.g., scaling) the reference appliance and dental appliance to the same or similar size scales, before aligning the reference appliance to the dental appliance.

At block 920, a difference between the reference appliance geometry and the dental appliance geometry is determined. The difference can be computed using a suitable 3D object comparison algorithm. In some embodiments, for example, the process of block 920 involves comparing pairs of points (e.g., vertices) on the reference appliance and the dental appliance. Specifically, for each point on the dental appliance, a corresponding point on the reference appliance can be identified. The corresponding point can be the point on the reference appliance that is closest to the point on the dental appliance. This process can be repeated until every point on the dental appliance has been paired with a corresponding point on the reference appliance. The distance between each pair of points can then be computed.

In some embodiments, the processes of blocks 918 and 920 involve determining a registration between the reference appliance geometry and the dental appliance geometry. The registration can include a coarse registration process to roughly align the reference appliance geometry to the dental appliance geometry, then a fine registration process to match each tooth-receiving cavity in the reference appliance geometry to a corresponding tooth-receiving cavity in the dental appliance geometry. Subsequently, corresponding points on the reference appliance and the dental appliance can be identified, based on the registration, and the distances between each pair of points can be computed.

At block 922, a transformation is calculated based on the difference between the reference appliance geometry and the dental appliance geometry. The transformation can be a function that morphs the reference appliance geometry into the dental appliance geometry. In some embodiments, the transformation is represented by a transformation matrix generated from the distances between paired points computed in block 920.

In some embodiments, the transformation includes at least one global transformation and at least one local transformation. The global transformation can be a transformation that is applied to a relatively large portion of the appliance geometry, such as to a tooth-receiving cavity or to the entire appliance. The global transformation can be a rigid transformation in which the shape of the appliance portion is maintained, but the position and/or orientation of the appliance portion can be changed. In some embodiments, the crown center of each tooth-receiving cavity is used as the control point for the global transformation, e.g., the global transformation is computed so that the crown center of each tooth-receiving cavity in the reference appliance is mapped onto the crown center of the corresponding tooth-receiving cavity in the dental appliance. The local transformation can be a transformation that is applied to a relatively small portion of the appliance geometry, such as to a portion of a tooth-receiving cavity (e.g., an occlusal portion, a buccal portion, a lingual portion, an interproximal portion, an interior portion, and/or an exterior portion). The local transformation can be a deformable (non-rigid) transformation in which the shape of the appliance portion can be changed, as well as the position and/or orientation of the appliance portion. In some embodiments, the global transformation is performed at a different time than the local transformation, e.g., the global transformation can be performed before the local transformation.

At block 924, the support structure arrangement for the dental appliance is generated by applying the transformation to the reference arrangement. For instance, the transformation matrix calculated in block 922 can be applied to a 3D digital representation of the reference arrangement to generate a transformed 3D digital representation, and the transformed 3D digital representation can be used as the support structure arrangement for the dental appliance. The 3D digital representations can be point clouds, mesh models, surface models, or any other model type that depicts the geometries of the reference arrangement and the support structure arrangement. In some embodiments, the transformation is applied to the entirety of the reference arrangement, while in other embodiments, the transformation is applied only to certain regions of the reference arrangement, such as the connection regions.

Referring again to FIG. 9A, the process of block 912 can use other techniques for generating the support structure arrangement, in addition or alternatively to the process illustrated in FIG. 9B. For instance, in other embodiments, a set of geometric parameters for the support structure arrangement can be generated by interpolation and/or approximation from geometric parameters of one or more reference arrangements, e.g., using a Bayesian optimization scheme with Gaussian process regression.

At block 914, the method 900 can include generating instructions for fabricating the dental appliance with the support structure arrangement. The process of block 914 can involve converting the output of block 912 (e.g., a 3D digital representation, a set of geometric parameters) into a format suitable for controlling an additive manufacturing system. The instructions can be a digital file including a 3D digital representation of the support structures (e.g., a CAD file, STL file, OBJ file, AMF file, 3MF file) and/or a toolpath file generated from the 3D digital representation (e.g., a G-code file), as previously described in connection with block 114 of FIG. 1.

At block 916, the method 900 can include fabricating the dental appliance with the support structure arrangement. The fabrication can be performed using an additive manufacturing technique, such as any of the embodiments described herein. The fabrication process can include producing the dental appliance and support structure arrangement via additive manufacturing, then post-processing the dental appliance (e.g., post-curing, cleaning, removing support structures), as described above in connection with block 116 of FIG. 1.

The method 900 can be performed using any suitable system or device. In some embodiments, some or all of the processes of the method 900 are implemented as computer-readable instructions (e.g., program code) that are configured to be executed by one or more processors of a computing device. Some or all of the processes of the method 900 can be performed by different systems or devices. For example, the processes of blocks 902, 904, and/or 906 can be performed by a treatment planning system; the processes of blocks 908, 910 and/or 912 can be performed by an appliance design system; and/or the processes of blocks 914 and/or 916 can be performed by a fabrication system.

### II. Dental Appliances and Associated Methods

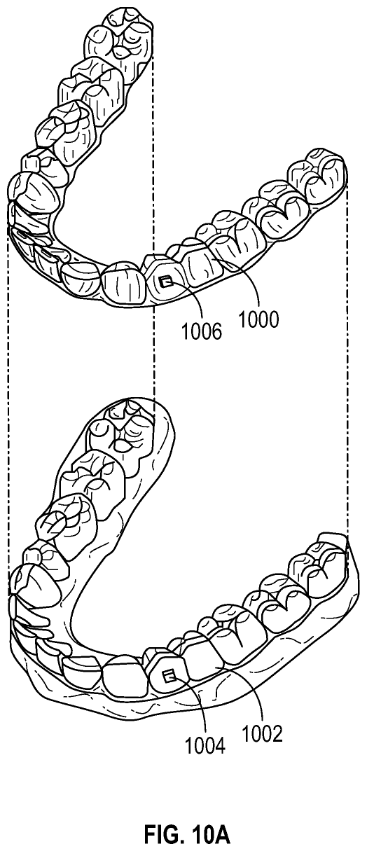

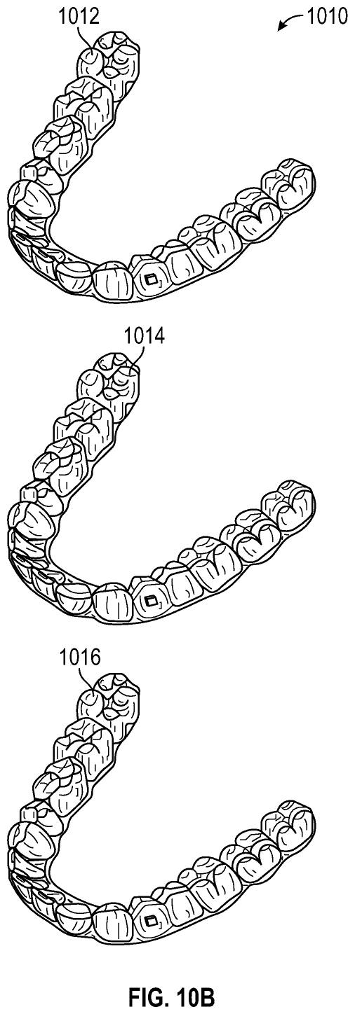

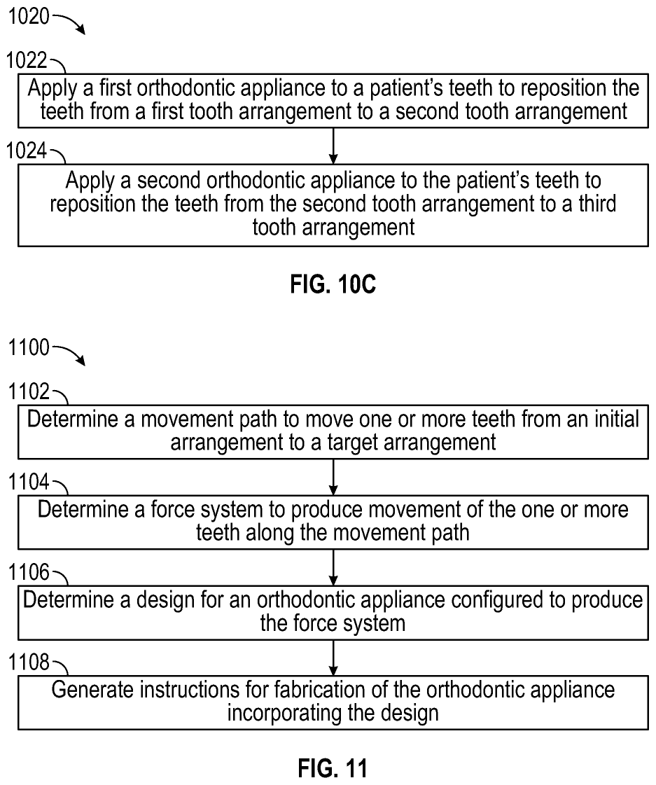

FIG. 10A illustrates a representative example of a tooth repositioning appliance 1000 configured in accordance with embodiments of the present technology. The appliance 1000 can be manufactured and post-processed using any of the systems, methods, and devices described herein. The appliance 1000 (also referred to herein as an “aligner”) can be worn by a patient in order to achieve an incremental repositioning of individual teeth 1002 in the jaw. The appliance 1000 can include a shell (e.g., a continuous polymeric shell or a segmented shell) having teeth-receiving cavities that receive and resiliently reposition the teeth. The appliance 1000 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1000 can fit over all teeth present in an upper or lower jaw, or less than all of the teeth. The appliance 1000 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1000 can be a generic appliance configured to receive the teeth, but not necessarily shaped to match the topography of the patient's teeth. In some cases, only certain teeth received by the appliance 1000 are repositioned by the appliance 1000 while other teeth can provide a base or anchor region for holding the appliance 1000 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1000 in place over the teeth. In some cases, however, it may be desirable or necessary to provide individual attachments 1004 or other anchoring elements on teeth 1002 with corresponding receptacles 1006 or apertures in the appliance 1000 so that the appliance 1000 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 10B illustrates a tooth repositioning system 1010 including a plurality of appliances 1012, 1014, 1016, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1010 can include a first appliance 1012 corresponding to an initial tooth arrangement, one or more intermediate appliances 1014 corresponding to one or more intermediate arrangements, and a final appliance 1016 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 10C illustrates a method 1020 of orthodontic treatment using a plurality of appliances, in accordance with embodiments of the present technology. The method 1020 can be practiced using any of the appliances or appliance sets described herein. In block 1022, a first orthodontic appliance is applied to a patient's teeth in order to reposition the teeth from a first tooth arrangement to a second tooth arrangement. In block 1024, a second orthodontic appliance is applied to the patient's teeth in order to reposition the teeth from the second tooth arrangement to a third tooth arrangement. The method 1020 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 11 illustrates a method 1100 for designing an orthodontic appliance, in accordance with embodiments of the present technology. The method 1100 can be applied to any embodiment of the orthodontic appliances described herein. Some or all of the steps of the method 1100 can be performed by any suitable data processing system or device, e.g., one or more processors configured with suitable instructions.

In block 1102, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1104, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1104 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1106, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1108, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1100 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1100 may be performed with any suitable fabrication system or device, such as the embodiments described herein. Some of the steps may be optional, e.g., the process of block 1102 can be omitted, such that the orthodontic appliance is designed based on the desired tooth movements and/or determined tooth movement path, rather than based on a force system. Moreover, the order of the steps can be varied as desired.

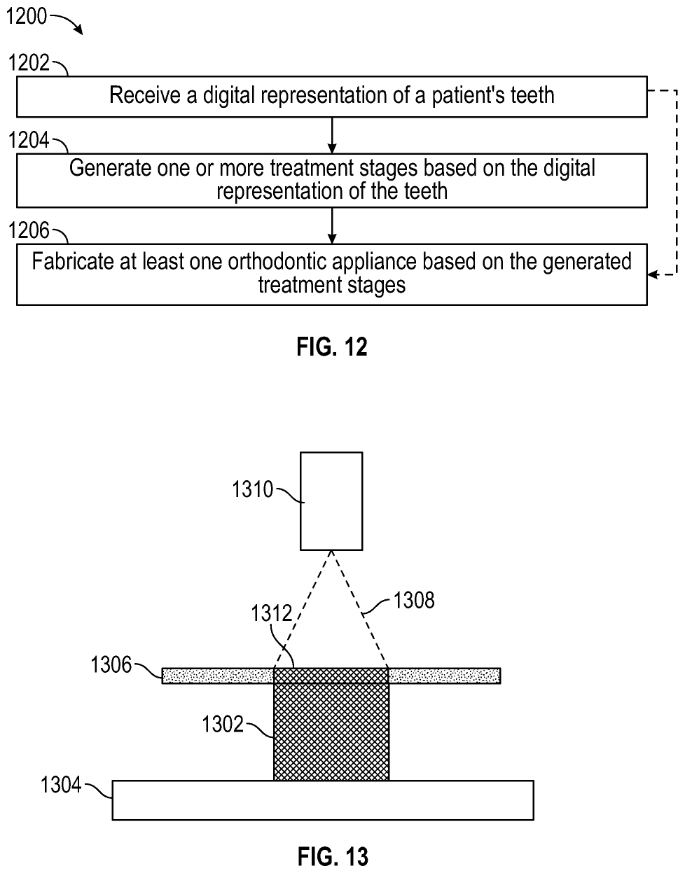

FIG. 12 illustrates a method 1200 for digitally planning an orthodontic treatment and/or design or fabrication of an appliance, in accordance with embodiments. The method 1200 can be applied to any of the treatment procedures described herein and can be performed by any suitable data processing system.

In block 1202 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1204, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1206, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 12, design and/or fabrication of an orthodontic appliance, and perhaps a particular orthodontic treatment, may include use of a representation of the patient's teeth (e.g., including receiving a digital representation of the patient's teeth (block 1202)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled, “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### III. Additive Manufacturing Technology

The systems, methods, and devices described herein are suitable for use with a wide variety of additive manufacturing techniques. Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,264 and U.S. Patent Publication No. 2014/0061974, the disclosures of which are incorporated herein by reference in their entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

FIG. 13 is a partially schematic diagram providing a general overview of an additive manufacturing process, in accordance with embodiments of the present technology. Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards).

In some embodiments, additive manufacturing includes depositing a precursor material (e.g., a polymeric resin) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

For example, in the embodiment of FIG. 13, an object 1302 is fabricated on a build platform 1304 from a series of cured material layers, with each layer having a geometry corresponding to a respective cross-section of the object 1302. To fabricate an individual object layer, a layer of curable material 1306 (e.g., polymerizable resin) is brought into contact with the build platform 1304 (when fabricating the first layer of the object 1302) or with the previously formed portion of the object 1302 on the build platform 1304 (when fabricating subsequent layers of the object 1302). In some embodiments, the curable material 1306 is formed on and supported by a substrate (not shown), such as a film. Energy 1308 (e.g., light) from an energy source 1310 (e.g., a laser, projector, or light engine) is then applied to the curable material 1306 to form a cured material layer 1312 on the build platform 1304 or on the object 1302. The remaining curable material 1306 can then be moved away from the build platform 1304 (e.g., by lowering the build platform 1304, by moving the build platform 1304 laterally, by raising the curable material 1306, and/or by moving the curable material 1306 laterally), thus leaving the cured material layer 1312 in place on the build platform 1304 and/or object 1302. The fabrication process can then be repeated with a fresh layer of uncured material 1306 to build up the next layer of the object 1302.

The illustrated embodiment shows a “top down” configuration in which the energy source 1310 is positioned above and directs the energy 1308 down toward the build platform 1304, such that the object 1302 is formed on the upper surface of the build platform 1304. Accordingly, the build platform 1304 can be incrementally lowered relative to the energy source 1310 as successive layers of the object 1302 are formed. In other embodiments, however, the additive manufacturing process of FIG. 13 can be performed using a “bottom up” configuration in which the energy source 1310 is positioned below and directs the energy 1308 up toward the build platform 1304, such that the object 1302 is formed on the lower surface of the build platform 1304. Accordingly, the build platform 1304 can be incrementally raised relative to the energy source 1310 as successive layers of the object 1302 are formed.

Although FIG. 13 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

### EXAMPLES

The following examples are included to further describe some aspects of the present technology, and should not be used to limit the scope of the technology.

Example 1. A method comprising:
receiving a digital representation of a dental appliance configured to implement a treatment stage of a treatment plan for a patient's teeth; and
generating a support structure arrangement configured to support the dental appliance during an additive manufacturing process, wherein the support structure arrangement is generated using a machine learning model, and wherein the machine learning model is trained on a training data set comprising:
   appliance data representing geometries of a plurality of dental appliances,
   support structure data representing geometries of a plurality of support structure arrangements, wherein each support structure arrangement is configured to support one of the plurality of dental appliances during the additive manufacturing process, and
   outcome data representing outcomes of the additive manufacturing process for the plurality of dental appliances with the respective support structure arrangements.

Example 2. The method of Example 1, wherein the appliance data is generated by:
receiving a 3D model of each dental appliance, and
parameterizing the 3D model into a set of appliance parameters for the corresponding dental appliance.

Example 3. The method of Example 2, wherein the set of appliance parameters comprises one or more of the following: curvature, thickness, location of the dental appliance on a build platform of an additive manufacturing system, location of the dental appliance within a print area of the additive manufacturing system, surface normal, distance to occlusal surface, appliance size, appliance complexity, tooth centroid, local overhang angle, or distance to closest supporting point.

Example 4. The method of any one of Examples 1 to 3, wherein the support structure data comprises a set of support structure parameters for each support structure arrangement.

Example 5. The method of Example 4, wherein the set of support structure parameters comprises one or more of the following: diameter, height, density, conic profile, non-conic profile, overhang, or turn/bend radius.

Example 6. The method of any one of Examples 1 to 5, wherein the outcome data comprises experimental data.

Example 7. The method of Example 6, wherein the experimental data is generated by:
fabricating one or more dental appliances with the respective support structure arrangements using the additive manufacturing process, and
testing the one or more dental appliances.

Example 8. The method of Example 7, wherein the outcome data comprises one or more of the following: data indicating whether the one or more dental appliances with the respective support structure arrangements were successfully fabricated, data representing dimensional accuracy of the one or more dental appliances, or data representing forces produced by the one or more dental appliances.

Example 9. The method of any one of Examples 6 to 8, wherein the experimental data is generated by:
receiving a digital representation of at least one dental appliance,
fabricating the at least one dental appliance with the respective support structure arrangement using the additive manufacturing process, based on the digital representation,
generating scan data of the fabricated at least one dental appliance, and
comparing the scan data to the digital representation.

Example 10. The method of any one of Examples 1 to 9, wherein the outcome data comprises simulation data.

Example 11. The method of Example 10, wherein the simulation data is generated by:
generating one or more models of one or more dental appliances with the respective support structure arrangements, and
performing at least one simulation using the one or more models.

Example 12. The method of Example 11, wherein the at least one simulation comprises using the one or more models to simulate one or more of stress or deformation in the one or more dental appliances with the respective support structure arrangements during additive manufacturing or post-processing.

Example 13. The method of any one of Examples 10 to 12, wherein at least some of the simulation data is experimentally validated.

Example 14. The method of any one of Examples 10 to 13, wherein at least some of the simulation data is not experimentally validated.

Example 15. The method of any one of Examples 1 to 14, wherein the outcome data further comprises data representing outcomes of the additive manufacturing process for a plurality of reference objects.

Example 16. The method of Example 15, wherein the plurality of reference objects comprises at least one coupon.

Example 17. The method of any one of Examples 1 to 16, wherein generating the support structure arrangement comprises:
receiving an initial digital representation of the dental appliance and the support structure arrangement, and
inputting the initial digital representation into the machine learning model, wherein the machine learning model is trained to predict a manufacturing outcome of the dental appliance and the support structure arrangement, and to output a modified digital representation in which one or more of the dental appliance or the support structure arrangement has been modified to improve the manufacturing outcome.

Example 18. The method of Example 17, wherein the initial digital representation comprises a mesh model.

Example 19. The method of Example 18, wherein the machine learning model is trained to identify one or more features in the mesh model, and to generate structured data representing the one or more features.

Example 20. The method of Example 17, wherein the initial digital representation comprises a plurality of images corresponding to a plurality of cross-sections of the dental appliance and the support structure arrangement.

Example 21. The method of Example 20, wherein the machine learning model comprises a convolutional neural network (CNN), and the modified digital representation comprises a plurality of modified images.

Example 22. The method of any one of Examples 17 to 21, wherein the modified digital representation comprises one or more of the following modifications: changing a shape of a portion of the dental appliance, changing a size of a portion of the dental appliance, changing a shape of a portion of a support structure, changing a size of a portion of a support structure, addition of a support structure, removal of a support structure, or a changing a location of a support structure.

Example 23. The method of any one of Examples 1 to 22, further comprising generating the treatment plan, wherein the treatment plan comprises a target arrangement and a plurality of intermediate arrangements to reposition the patient's teeth from an initial arrangement toward the target arrangement.

Example 24. The method of Example 23, further comprising receiving a digital representation of the initial arrangement of the patient's teeth.

Example 25. The method of any one of Examples 1 to 24, further comprising generating instructions configured to cause a fabrication system to fabricate the dental appliance with the support structure arrangement using the additive manufacturing process.

Example 26. The method of Example 25, further comprising transmitting the instructions to the fabrication system.

Example 27. The method of any one of Examples 1 to 26, wherein the support structure arrangement comprises one or more of the following: a strut, a curved arm, a crossbar, or a block.

Example 28. The method of any one of Examples 1 to 27, wherein the support structure arrangement is configured to support the dental appliance in a horizontal orientation, a vertical orientation, or a tilted orientation.

Example 29. The method of any one of Examples 1 to 28, wherein the support structure arrangement is configured to support the dental appliance and a second dental appliance.

Example 30. The method of any one of Examples 1 to 29, wherein the additive manufacturing process comprises fabricating the dental appliance and the support structure arrangement from a plurality of layers of a precursor material.

Example 31. The method of any one of Examples 1 to 30, wherein the additive manufacturing process comprises stereolithography, digital light processing, selective laser sintering, material jetting, or a combination thereof.

Example 32. The method of any one of Examples 1 to 31, wherein the dental appliance is an aligner, a retainer, a palatal expander, or an attachment placement device.

Example 33. A system comprising:
one or more processors; and
a memory operably coupled to the one or more processors and storing instructions that, when executed by the one or more processors, cause the system to perform operations comprising:
   receiving a digital representation of a dental appliance configured to implement a treatment stage of a treatment plan for a patient's teeth; and
   generating a support structure arrangement configured to support the dental appliance during an additive manufacturing process, wherein the support structure arrangement is generated using a machine learning model, and wherein the machine learning model is trained on a training data set comprising:
      appliance data representing geometries of a plurality of dental appliances,
      support structure data representing geometries of a plurality of support structure arrangements, wherein each support structure arrangement is configured to support one of the plurality of dental appliances during the additive manufacturing process, and
      outcome data representing outcomes of the additive manufacturing process for the plurality of dental appliances with the respective support structure arrangements.

Example 34. The system of Example 33, wherein the appliance data is generated by:
receiving a 3D model of each dental appliance, and
parameterizing the 3D model into a set of appliance parameters for the corresponding dental appliance.

Example 35. The system of Example 34, wherein the set of appliance parameters comprises one or more of the following: curvature, thickness, location of the dental appliance on a build platform of an additive manufacturing system, location of the dental appliance within a print area of the additive manufacturing system, surface normal, distance to occlusal surface, appliance size, appliance complexity, tooth centroid, local overhang angle, or distance to closest supporting point.

Example 36. The system of any one of Examples 33 to 35, wherein the support structure data comprises a set of support structure parameters for each support structure arrangement.

Example 37. The system of Example 36, wherein the set of support structure parameters comprises one or more of the following: diameter, height, density, conic profile, non-conic profile, overhang, and turn/bend radius.

Example 38. The system of any one of Examples 33 to 37, wherein the outcome data comprises experimental data.

Example 39. The system of Example 38, wherein the experimental data is generated by:
fabricating one or more dental appliances with the respective support structure arrangements using the additive manufacturing process, and
testing the one or more dental appliances.

Example 40. The system of Example 39, wherein the outcome data comprises one or more of the following: data indicating whether the one or more dental appliances with the respective support structure arrangements were successfully fabricated, data representing dimensional accuracy of the one or more dental appliances, or data representing forces produced by the one or more dental appliances.

Example 41. The system of any one of Examples 38 to 40, wherein the experimental data is generated by:
receiving a digital representation of at least one dental appliance,
fabricating the at least one dental appliance with the respective support structure arrangement using the additive manufacturing process, based on the digital representation,
generating scan data of the fabricated at least one dental appliance, and
comparing the scan data to the digital representation.

Example 42. The system of any one of Examples 33 to 41, wherein the outcome data comprises simulation data.

Example 43. The system of Example 42, wherein the simulation data is generated by:
generating one or more models of one or more dental appliances with the respective support structure arrangements, and
performing at least one simulation using the one or more models.

Example 44. The system of Example 43, wherein the at least one simulation comprises using the one or more models to simulate one or more of stress or deformation in the one or more dental appliances with the respective support structure arrangements during additive manufacturing or post-processing.

Example 45. The system of any one of Examples 42 to 44, wherein at least some of the simulation data is experimentally validated.

Example 46. The system of any one of Examples 42 to 45, wherein at least some of the simulation data is not experimentally validated.

Example 47. The system of any one of Examples 33 to 46, wherein the outcome data further comprises data representing outcomes of the additive manufacturing process for a plurality of reference objects.

Example 48. The system of Example 47, wherein the plurality of reference objects comprises at least one coupon.

Example 49. The system of any one of Examples 33 to 48, wherein generating the support structure arrangement comprises:
receiving an initial digital representation of the dental appliance and the support structure arrangement, and
inputting the initial digital representation into the machine learning model, wherein the machine learning model is trained to predict a manufacturing outcome of the dental appliance and the support structure arrangement, and to output a modified digital representation in which one or more of the dental appliance or the support structure arrangement has been modified to improve the manufacturing outcome.

Example 50. The system of Example 49, wherein the initial digital representation comprises a mesh model.

Example 51. The system of Example 50, wherein the machine learning model is trained to identify one or more features in the mesh model, and to generate structured data representing the one or more features.

Example 52. The system of Example 49, wherein the initial digital representation comprises a plurality of images corresponding to a plurality of cross-sections of the dental appliance and the support structure arrangement.

Example 53. The system of Example 52, wherein the machine learning model comprises a convolutional neural network (CNN), and the modified digital representation comprises a plurality of modified images.

Example 54. The system of any one of Examples 49 to 53, wherein the modified digital representation comprises one or more of the following modifications: changing a shape of a portion of the dental appliance, changing a size of a portion of the dental appliance, changing a shape of a portion of a support structure, changing a size of a portion of a support structure, addition of a support structure, removal of a support structure, or a changing a location of a support structure.

Example 55. The system of any one of Examples 33 to 54, wherein the operations further comprise generating the treatment plan, wherein the treatment plan comprises a target arrangement and a plurality of intermediate arrangements to reposition the patient's teeth from an initial arrangement toward the target arrangement.

Example 56. The system of Example 55, wherein the operations further comprise receiving a digital representation of the initial arrangement of the patient's teeth.

Example 57. The system of any one of Examples 33 to 56, wherein the operations further comprise generating instructions configured to cause a fabrication system to fabricate the dental appliance with the support structure arrangement using the additive manufacturing process.

Example 58. The system of Example 57, wherein the operations further comprise transmitting the instructions to the fabrication system.

Example 59. The system of any one of Examples 33 to 58, wherein the support structure arrangement comprises one or more of the following: a strut, a curved arm, a crossbar, or a block.

Example 60. The system of any one of Examples 33 to 59, wherein the support structure arrangement is configured to support the dental appliance in a horizontal orientation, a vertical orientation, or a tilted orientation.

Example 61. The system of any one of Examples 33 to 60, wherein the support structure arrangement is configured to support the dental appliance and a second dental appliance.

Example 62. The system of any one of Examples 33 to 61, wherein the additive manufacturing process comprises fabricating the dental appliance and the support structure arrangement from a plurality of layers of a precursor material.

Example 63. The system of any one of Examples 33 to 62, wherein the additive manufacturing process comprises stereolithography, digital light processing, selective laser sintering, material jetting, or a combination thereof.

Example 64. The system of any one of Examples 33 to 63, wherein the dental appliance is an aligner, a retainer, a palatal expander, or an attachment placement device.

Example 65. A non-transitory computer-readable storage medium comprising instructions that, when executed by one or more processors of a computing system, cause the computing system to perform operations comprising the method of any one of Examples 1 to 32.

Example 66. A method comprising:
obtaining a training data set comprising:
   appliance data representing geometries of a plurality of dental appliances,
   support structure data representing geometries of a plurality of support structure arrangements, wherein each support structure arrangement is configured to support one of the plurality of dental appliances during an additive manufacturing process, and
   outcome data representing outcomes of the additive manufacturing process for the plurality of dental appliances with the respective support structure arrangements; and
training a machine learning model using the training data set.

Example 67. The method of Example 66, wherein the appliance data is generated by:
receiving a 3D model of each dental appliance, and
parameterizing the 3D model into a set of appliance parameters for the corresponding dental appliance.

Example 68. The method of Example 67, wherein the set of appliance parameters comprises one or more of the following: curvature, thickness, location of the dental appliance on a build platform of an additive manufacturing system, location of the dental appliance within a print area of the additive manufacturing system, surface normal, distance to occlusal surface, appliance size, appliance complexity, tooth centroid, local overhang angle, or distance to closest supporting point.

Example 69. The method of any one of Examples 66 to 68, wherein the support structure data comprises a set of support structure parameters for each support structure arrangement.

Example 70. The method of Example 69, wherein the set of support structure parameters comprises one or more of the following: diameter, height, density, conic profile, non-conic profile, overhang, or turn/bend radius.

Example 71. The method of any one of Examples 66 to 70, wherein the outcome data comprises experimental data.

Example 72. The method of Example 71, wherein the experimental data is generated by:
fabricating one or more dental appliances with the respective support structure arrangements using the additive manufacturing process, and
testing the one or more dental appliances.

Example 73. The method of Example 72, wherein the outcome data comprises data indicating whether the one or more dental appliances with the respective support structure arrangements were successfully fabricated.

Example 74. The method of Example 72 or 73, wherein the outcome data comprises data representing dimensional accuracy of the one or more dental appliances.

Example 75. The method of any one of Examples 72 to 74, wherein the outcome data comprises data representing forces produced by the one or more dental appliances.

Example 76. The method of any one of Examples 71 to 75, wherein the experimental data is generated by:
receiving a digital representation of at least one dental appliance,
fabricating the at least one dental appliance with the respective support structure arrangement using the additive manufacturing process, based on the digital representation,
generating scan data of the fabricated at least one dental appliance, and
comparing the scan data to the digital representation.

Example 77. The method of any one of Examples 66 to 76, wherein the outcome data comprises simulation data.

Example 78. The method of Example 77, wherein the simulation data is generated by:
generating one or more models of one or more dental appliances with the respective support structure arrangements, and
performing at least one simulation using the one or more models.

Example 79. The method of Example 78, wherein the at least one simulation comprises using the one or more models to simulate stress in the one or more dental appliances with the respective support structure arrangements during additive manufacturing or post-processing.

Example 80. The method of Example 78 or 79, wherein the at least one simulation comprises using the one or more models to simulate deformation of the one or more dental appliances during additive manufacturing or post-processing.

Example 81. The method of any one of Examples 77 to 81, wherein at least some of the simulation data is experimentally validated.

Example 82. The method of any one of Examples 77 to 82, wherein at least some of the simulation data is not experimentally validated.

Example 83. The method of any one of Examples 66 to 82, wherein the outcome data further comprises data representing outcomes of the additive manufacturing process for a plurality of reference objects.

Example 84. The method of Example 83, wherein the plurality of reference objects comprises at least one coupon.

Example 85. The method of any one of Examples 66 to 84, further comprising using the trained machine learning model to generate a support structure arrangement for a dental appliance.

Example 86. The method of Example 85, wherein generating the support structure arrangement comprises:
receiving an initial digital representation of the dental appliance and the support structure arrangement, and
inputting the initial digital representation into the machine learning model, wherein the machine learning model is trained to predict a manufacturing outcome of the dental appliance and the support structure arrangement, and to output a modified digital representation in which one or more of the dental appliance or the support structure arrangement has been modified to improve the manufacturing outcome.

Example 87. The method of Example 86, wherein the initial digital representation comprises a mesh model.

Example 88. The method of Example 87, wherein the machine learning model is trained to identify one or more features in the mesh model, and to generate structured data representing the one or more features.

Example 89. The method of Example 86, wherein the initial digital representation comprises a plurality of images corresponding to a plurality of cross-sections of the dental appliance and the support structure arrangement.

Example 90. The method of Example 89, wherein the machine learning model comprises a convolutional neural network (CNN), and the modified digital representation comprises a plurality of modified images.

Example 91. The method of any one of Examples 86 to 90, wherein the modified digital representation comprises one or more of the following modifications: changing a shape of a portion of the dental appliance, changing a size of a portion of the dental appliance, changing a shape of a portion of a support structure, changing a size of a portion of a support structure, addition of a support structure, removal of a support structure, or a changing a location of a support structure.

Example 92. The method of any one of Examples 85 to 91, wherein the support structure arrangement comprises one or more of the following: a strut, a curved arm, a crossbar, or a block.

Example 93. The method of any one of Examples 85 to 92, wherein the support structure arrangement is configured to support the dental appliance in a horizontal orientation, a vertical orientation, or a tilted orientation.

Example 94. The method of any one of Examples 85 to 93, wherein the support structure arrangement is configured to support the dental appliance and a second dental appliance.

Example 95. A system comprising:
a datastore comprising a training data set comprising:
   appliance data representing geometries of a plurality of dental appliances,
   support structure data representing geometries of a plurality of support structure arrangements, wherein each support structure arrangement is configured to support one of the plurality of dental appliances during an additive manufacturing process, and
   outcome data representing outcomes of the additive manufacturing process for the plurality of dental appliances with the respective support structure arrangements;
one or more processors; and
a memory operably coupled to the one or more processors and storing instructions that, when executed by the one or more processors, cause the computing system to perform operations comprising training a machine learning model using the training data set.

Example 96. The system of Example 95, wherein the appliance data is generated by:
receiving a 3D model of each dental appliance, and
parameterizing the 3D model into a set of appliance parameters for the corresponding dental appliance.

Example 97. The system of Example 96, wherein the set of appliance parameters comprises one or more of the following: curvature, thickness, location of the dental appliance on a build platform of an additive manufacturing system, location of the dental appliance within a print area of the additive manufacturing system, surface normal, distance to occlusal surface, appliance size, appliance complexity, tooth centroid, local overhang angle, or distance to closest supporting point.

Example 98. The system of any one of Examples 95 to 97, wherein the support structure data comprises a set of support structure parameters for each support structure arrangement.

Example 99. The system of Example 98, wherein the set of support structure parameters comprises one or more of the following: diameter, height, density, conic profile, non-conic profile, overhang, or turn/bend radius.

Example 100. The system of any one of Examples 95 to 99, wherein the outcome data comprises experimental data.

Example 101. The system of Example 100, wherein the experimental data is generated by:
fabricating one or more dental appliances with the respective support structure arrangements using the additive manufacturing process, and
testing the one or more dental appliances.

Example 102. The system of Example 101, wherein the outcome data comprises data indicating whether the one or more dental appliances with the respective support structure arrangements were successfully fabricated.

Example 103. The system of Example 101 or 102, wherein the outcome data comprises data representing dimensional accuracy of the one or more dental appliances.

Example 104. The system of any one of Examples 101 to 103, wherein the outcome data comprises data representing forces produced by the one or more dental appliances.

Example 105. The system of any one of Examples 100 to 104, wherein the experimental data is generated by:
receiving a digital representation of at least one dental appliance,
fabricating the at least one dental appliance with the respective support structure arrangement using the additive manufacturing process, based on the digital representation,
generating scan data of the fabricated at least one dental appliance, and
comparing the scan data to the digital representation.

Example 106. The system of any one of Examples 95 to 105, wherein the outcome data comprises simulation data.

Example 107. The system of Example 106, wherein the simulation data is generated by:
generating one or more models of one or more dental appliances with the respective support structure arrangements, and
performing at least one simulation using the one or more models.

Example 108. The system of Example 107, wherein the at least one simulation comprises using the one or more models to simulate stress in the one or more dental appliances with the respective support structure arrangements during additive manufacturing or post-processing.

Example 109. The system of Example 107 or 108, wherein the at least one simulation comprises using the one or more models to simulate deformation of the one or more dental appliances during additive manufacturing or post-processing.

Example 110. The system of any one of Examples 106 to 109, wherein at least some of the simulation data is experimentally validated.

Example 111. The system of any one of Examples 106 to 110, wherein at least some of the simulation data is not experimentally validated.

Example 112. The system of any one of Examples 95 to 111, wherein the outcome data further comprises data representing outcomes of the additive manufacturing process for a plurality of reference objects.

Example 113. The system of Example 112, wherein the plurality of reference objects comprises at least one coupon.

Example 114. The system of any one of Examples 95 to 113, wherein the operations further comprise using the trained machine learning model to generate a support structure arrangement for a dental appliance.

Example 115. The system of Example 114, wherein the support structure arrangement is generated by:
receiving an initial digital representation of the dental appliance and the support structure arrangement, and
inputting the initial digital representation into the machine learning model, wherein the machine learning model is trained to predict a manufacturing outcome of the dental appliance and the support structure arrangement, and to output a modified digital representation in which one or more of the dental appliance or the support structure arrangement has been modified to improve the manufacturing outcome.

Example 116. The system of Example 115, wherein the initial digital representation comprises a mesh model.

Example 117. The system of Example 116, wherein the machine learning model is trained to identify one or more features in the mesh model, and to generate structured data representing the one or more features.

Example 118. The system of Example 115, wherein the initial digital representation comprises a plurality of images corresponding to a plurality of cross-sections of the dental appliance and the support structure arrangement.

Example 119. The system of Example 118, wherein the machine learning model comprises a convolutional neural network (CNN), and the modified digital representation comprises a plurality of modified images.

Example 120. The system of any one of Examples 115 to 119, wherein the modified digital representation comprises one or more of the following modifications: changing a shape of a portion of the dental appliance, changing a size of a portion of the dental appliance, changing a shape of a portion of a support structure, changing a size of a portion of a support structure, addition of a support structure, removal of a support structure, or a changing a location of a support structure.

Example 121. The system of any one of Examples 114 to 120, wherein the support structure arrangement comprises one or more of the following: a strut, a curved arm, a crossbar, or a block.

Example 122. The system of any one of Examples 114 to 121, wherein the support structure arrangement is configured to support the dental appliance in a horizontal orientation, a vertical orientation, or a tilted orientation.

Example 123. The system of any one of Examples 114 to 122, wherein the support structure arrangement is configured to support the dental appliance and a second dental appliance.

Example 124. A non-transitory computer-readable storage medium comprising instructions that, when executed by one or more processors of a computing system, cause the computing system to perform operations comprising the method of any one of Examples 66 to 94.

Example 125. A method comprising:
receiving a digital representation of a geometry of a dental appliance configured to implement a treatment stage of a treatment plan for a patient's teeth;
accessing a datastore comprising a plurality of reference data sets, each reference data set comprising a reference appliance and a reference support structure arrangement associated with the reference appliance;
identifying a reference appliance having a geometry similar to the geometry of the dental appliance; and
generating a support structure arrangement for the dental appliance based on the reference support structure arrangement associated with the identified reference appliance.

Example 126. The method of Example 125, wherein at least some of the reference data sets are generated based on experimental data.

Example 127. The method of Example 125 or 126, wherein at least some of the reference data sets are generated based on simulation data.

Example 128. The method of any one of Examples 125 to 127, wherein the plurality of reference data sets represent a plurality of different reference appliances.

Example 129. The method of any one of Examples 125 to 128, wherein the support structure arrangement is configured to support the dental appliance during an additive manufacturing process.

Example 130. The method of Example 129, wherein the additive manufacturing process comprises fabricating the dental appliance and the support structure arrangement from a plurality of layers of a precursor material.

Example 131. The method of Example 129 or 130, wherein the additive manufacturing process comprises stereolithography, digital light processing, selective laser sintering, material jetting, or a combination thereof.

Example 132. The method of any one of Examples 129 to 131, wherein each reference support structure arrangement represents a plurality of support structures configured to support a respective reference appliance during the additive manufacturing process.

Example 133. The method of any one of Examples 125 to 132, wherein identifying the reference appliance comprises comparing at least one geometric parameter of the reference appliance to at least one corresponding geometric parameter of the dental appliance.

Example 134. The method of any one of Examples 125 to 133, wherein identifying the reference appliance comprises computing a similarity score between the reference appliance and the dental appliance.

Example 135. The method of Example 134, wherein the similarity score is computed using a minimization algorithm.

Example 136. The method of any one of Examples 125 to 135, wherein generating the support structure arrangement comprises applying a transformation to the reference support structure arrangement associated with the identified reference appliance.

Example 137. The method of Example 136, further comprising determining the transformation using the geometry of the reference appliance and the geometry of the dental appliance.

Example 138. The method of Example 137, wherein the transformation is configured to transform the geometry of the reference appliance into the geometry of the dental appliance.

Example 139. The method of Example 137 or 138, wherein determining the transformation comprises:
aligning the reference appliance to the dental appliance,
determining a difference between the geometry of the reference appliance and the geometry of the dental appliance, and
calculating a transformation matrix based on the difference.

Example 140. The method of any one of Examples 136 to 139, wherein the transformation is applied only to connection regions of the reference support structure arrangement.

Example 141. The method of any one of Examples 136 to 139, wherein the transformation is applied to the entirety of the reference support structure arrangement.

Example 142. The method of any one of Examples 125 to 141, further comprising generating the treatment plan, wherein the treatment plan comprises a target arrangement and a plurality of intermediate arrangements to reposition the patient's teeth from an initial arrangement toward the target arrangement.

Example 143. The method of Example 142, further comprising receiving a digital representation of the initial arrangement of the patient's teeth.

Example 144. The method of any one of Examples 124 to 143, further comprising generating instructions configured to cause a fabrication system to fabricate the dental appliance with the support structure arrangement using an additive manufacturing process.

Example 145. The method of Example 144, further comprising transmitting the instructions to the fabrication system.

Example 146. The method of any one of Examples 125 to 145, wherein the support structure arrangement comprises one or more of the following: a strut, a curved arm, a crossbar, or a block.

Example 147. The method of any one of Examples 125 to 146, wherein the support structure arrangement is configured to support the dental appliance in a horizontal orientation, a vertical orientation, or a tilted orientation.

Example 148. The method of any one of Examples 125 to 147, wherein the support structure arrangement is configured to support the dental appliance and a second dental appliance.

Example 149. The method of any one of Examples 125 to 148, wherein the dental appliance is an aligner, a retainer, a palatal expander, or an attachment placement device.

Example 150. A system comprising:
a processor; and
a memory operably coupled to the processor and storing instructions that, when executed by the processor, cause the system to perform operations comprising:
   receiving a digital representation of a geometry of a dental appliance configured to implement a treatment stage of a treatment plan for a patient's teeth;
   accessing a datastore comprising a plurality of reference data sets, each reference data set comprising a reference appliance and a reference support structure arrangement associated with the reference appliance;
   identifying a reference appliance having a geometry similar to the geometry of the dental appliance; and
   generating a support structure arrangement for the dental appliance based on the reference support structure arrangement associated with the identified reference appliance.

Example 151. The system of Example 150, wherein at least some of the reference data sets are generated based on experimental data.

Example 152. The system of Example 150 or 151, wherein at least some of the reference data sets are generated based on simulation data.

Example 153. The system of any one of Examples 150 to 152, wherein the plurality of reference data sets represent a plurality of different reference appliances.

Example 154. The system of any one of Examples 150 to 153, wherein the support structure arrangement is configured to support the dental appliance during an additive manufacturing process.

Example 155. The system of Example 154, wherein the additive manufacturing process comprises fabricating the dental appliance and the support structure arrangement from a plurality of layers of a precursor material.

Example 156. The system of Example 154 or 155, wherein the additive manufacturing process comprises stereolithography, digital light processing, selective laser sintering, material jetting, or a combination thereof.

Example 157. The system of any one of Examples 154 to 156, wherein each reference support structure arrangement represents a plurality of support structures configured to support a respective reference appliance during the additive manufacturing process.

Example 158. The system of any one of Examples 150 to 157, wherein identifying the reference appliance comprises comparing at least one geometric parameter of the reference appliance to at least one corresponding geometric parameter of the dental appliance.

Example 159. The system of any one of Examples 150 to 158, wherein identifying the reference appliance comprises computing a similarity score between the reference appliance and the dental appliance.

Example 160. The system of Example 159, wherein the similarity score is computed using a minimization algorithm.

Example 161. The system of any one of Examples 150 to 160, wherein generating the support structure arrangement comprises applying a transformation to the reference support structure arrangement associated with the identified reference appliance.

Example 162. The system of Example 161, further comprising determining the transformation using the geometry of the reference appliance and the geometry of the dental appliance.

Example 163. The system of Example 162, wherein the transformation is configured to transform the geometry of the reference appliance into the geometry of the dental appliance.

Example 164. The system of Example 162 or 163, wherein determining the transformation comprises:
aligning the reference appliance to the dental appliance,
determining a difference between the geometry of the reference appliance and the geometry of the dental appliance, and
calculating a transformation matrix based on the difference.

Example 165. The system of any one of Examples 161 to 164, wherein the transformation is applied only to connection regions of the reference support structure arrangement.

Example 166. The system of any one of Examples 161 to 164, wherein the transformation is applied to the entirety of the reference support structure arrangement.

Example 167. The system of any one of Examples 150 to 166, wherein the operations further comprise generating the treatment plan, wherein the treatment plan comprises a target arrangement and a plurality of intermediate arrangements to reposition the patient's teeth from an initial arrangement toward the target arrangement.

Example 168. The system of Example 167, wherein the operations further comprise receiving a digital representation of the initial arrangement of the patient's teeth.

Example 169. The system of any one of Examples 150 to 168, wherein the operations further comprise generating instructions configured to cause a fabrication system to fabricate the dental appliance with the support structure arrangement using an additive manufacturing process.

Example 170. The system of Example 169, wherein the operations further comprise transmitting the instructions to the fabrication system.

Example 171. The system of any one of Examples 150 to 170, wherein the support structure arrangement comprises one or more of the following: a strut, a curved arm, a crossbar, or a block.

Example 172. The system of any one of Examples 150 to 171, wherein the support structure arrangement is configured to support the dental appliance in a horizontal orientation, a vertical orientation, or a tilted orientation.

Example 173. The system of any one of Examples 150 to 172, wherein the support structure arrangement is configured to support the dental appliance and a second dental appliance.

Example 174. The system of any one of Examples 150 to 173, wherein the dental appliance is an aligner, a retainer, a palatal expander, or an attachment placement device.

Example 175. A non-transitory computer-readable storage medium comprising instructions that, when executed by one or more processors of a computing system, cause the computing system to perform operations comprising the method of any one of Examples 124 to 149.

### Conclusion

Although many of the embodiments are described above with respect to systems, devices, and methods for manufacturing dental appliances, the technology is applicable to other applications and/or other approaches, such as manufacturing dental molds (e.g., for thermoforming of dental appliances) and/or other types of additively manufactured objects. Moreover, other embodiments in addition to those described herein are within the scope of the technology.

Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-13.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method comprising:
receiving a digital representation of a dental appliance configured to implement a treatment stage of a treatment plan for a patient's teeth; and
generating a support structure arrangement configured to support the dental appliance during an additive manufacturing process, wherein the support structure arrangement is generated using a machine learning model, and wherein the machine learning model is trained on a training data set comprising:
appliance data representing geometries of a plurality of dental appliances,
support structure data representing geometries of a plurality of support structure arrangements, wherein each support structure arrangement is configured to support one of the plurality of dental appliances during the additive manufacturing process, and
outcome data representing outcomes of the additive manufacturing process for the plurality of dental appliances with the respective support structure arrangements.

2. The method of claim 1, wherein the appliance data is generated by:
receiving a 3D model of each dental appliance, and
parameterizing the 3D model into a set of appliance parameters for the corresponding dental appliance.

3. The method of claim 2, wherein the set of appliance parameters comprises one or more of the following: curvature, thickness, location of the dental appliance on a build platform of an additive manufacturing system, location of the dental appliance within a print area of the additive manufacturing system, surface normal, distance to occlusal surface, appliance size, appliance complexity, tooth centroid, local overhang angle, or distance to closest supporting point.

4. The method of claim 1, wherein the support structure data comprises a set of support structure parameters for each support structure arrangement.

5. The method of claim 4, wherein the set of support structure parameters comprises one or more of the following: diameter, height, density, conic profile, non-conic profile, overhang, or turn/bend radius.

6. The method of claim 1, wherein the outcome data comprises experimental data.

7. The method of claim 6, wherein the experimental data is generated by:
fabricating one or more dental appliances with the respective support structure arrangements using the additive manufacturing process, and
testing the one or more dental appliances.

8. The method of claim 7, wherein the outcome data comprises one or more of the following: data indicating whether the one or more dental appliances with the respective support structure arrangements were successfully fabricated, data representing dimensional accuracy of the one or more dental appliances, or data representing forces produced by the one or more dental appliances.

9. The method of claim 6, wherein the experimental data is generated by:
receiving a digital representation of at least one dental appliance,
fabricating the at least one dental appliance with the respective support structure arrangement using the additive manufacturing process, based on the digital representation,
generating scan data of the fabricated at least one dental appliance, and
comparing the scan data to the digital representation.

10. The method of claim 1, wherein the outcome data comprises simulation data.

11. The method of claim 10, wherein the simulation data is generated by:
generating one or more models of one or more dental appliances with the respective support structure arrangements, and
performing at least one simulation using the one or more models.

12. The method of claim 11, wherein the at least one simulation comprises using the one or more models to simulate one or more of stress or deformation in the one or more dental appliances with the respective support structure arrangements during additive manufacturing or post-processing.

13. The method of claim 1, wherein the outcome data further comprises data representing outcomes of the additive manufacturing process for a plurality of reference objects.

14. The method of claim 1, wherein generating the support structure arrangement comprises:
receiving an initial digital representation of the dental appliance and the support structure arrangement, and
inputting the initial digital representation into the machine learning model, wherein the machine learning model is trained to predict a manufacturing outcome of the dental appliance and the support structure arrangement, and to output a modified digital representation in which one or more of the dental appliance or the support structure arrangement has been modified to improve the manufacturing outcome.

15. The method of claim 14, wherein the initial digital representation comprises a mesh model.

16. The method of claim 15, wherein the machine learning model is trained to identify one or more features in the mesh model, and to generate structured data representing the one or more features.

17. The method of claim 14, wherein the initial digital representation comprises a plurality of images corresponding to a plurality of cross-sections of the dental appliance and the support structure arrangement.

18. The method of claim 17, wherein the machine learning model comprises a convolutional neural network (CNN), and the modified digital representation comprises a plurality of modified images.

19. The method of claim 14, wherein the modified digital representation comprises one or more of the following modifications: changing a shape of a portion of the dental appliance, changing a size of a portion of the dental appliance, changing a shape of a portion of a support structure, changing a size of a portion of a support structure, addition of a support structure, removal of a support structure, or a changing a location of a support structure.

20. The method of claim 1, further comprising generating instructions configured to cause a fabrication system to fabricate the dental appliance with the support structure arrangement using the additive manufacturing process, wherein the additive manufacturing process comprises fabricating the dental appliance and the support structure arrangement from a plurality of layers of a precursor material.
